(19) United States
(12) Patent Application Publication
(10) Pub. No.: US 2013/0211706 A1
(43) Pub. Date: Aug. 15, 2013

(54) SYSTEMS, METHODS, AND PROCESSOR READABLE MEDIA FOR TRAFFIC FLOW MEASUREMENT

(71) Applicants: Malcolm David MacNaughtan, Cherrybrook (AU); Christopher Ridgway Drane, Pymble (AU); Stephen Frank Brown, West Ryde (AU); Craig Andrew Scott, Mortdale (AU)

(72) Inventors: Malcolm David MacNaughtan, Cherrybrook (AU); Christopher Ridgway Drane, Pymble (AU); Stephen Frank Brown, West Ryde (AU); Craig Andrew Scott, Mortdale (AU)

(73) Assignee: WAVEMARKET, INC., Emeryville, CA (US)

(21) Appl. No.: 13/816,130

(22) PCT Filed: Aug. 12, 2011
(86) PCT No.: PCT/AU2011/001038

§ 371 Date: Apr. 18, 2013

Related U.S. Application Data
(60) Provisional application No. 61/344,522, filed on Aug. 13, 2010.

(51) Int. Cl. G08G 1/052; H04W 88/00; H04W 4/02

(52) U.S. Cl. CPC G08G 1/052; H04W 4/02; H04W 88/00
USPC 701/410

(57) ABSTRACT

Systems, methods, and processor readable media for estimating the speed of a mobile radio terminal traveling on at least one road segment are disclosed. Certain embodiments are characterized by determining one or more routes through a road network that a mobile radio terminal could have traveled based on a sequence of wireless measurements from the mobile radio terminal. In addition, systems, methods, and processor readable media for collecting and transmitting radio communications network measurements from a mobile terminal for use in a system of estimating a traffic flow speed on road segments are disclosed. Certain embodiments are characterized by accumulating and communicating a plurality of wireless measurements to a traffic flow measurement server such that reporting of wireless measurements is minimized when the mobile radio terminal is stationary.

### CROSS-REFERENCE TO RELATED APPLICATIONS

This application claims the benefit of U.S. provisional application No. 61/344,522, filed Aug. 13, 2010, which is incorporated by reference as if fully set forth.

The present application is related to the following co-pending patent applications:
PCT/AU09/000,436 entitled “Efficient Collection of Wireless Transmitter Characteristics”, and
PCT/AU09/000,438 entitled “Location of Wireless Mobile Terminals”

The entire content of each of these applications is hereby incorporated by reference.

Furthermore, the entire contents of the following references are hereby incorporated by reference. W. C. Y. Lee, Mobile Communications Engineering, McGraw-Hill, 1982, IEEE VTS committee, “Coverage prediction for mobile radio systems operating in the 800/900 MHz frequency range”, IEEE Transactions on VTC, Vol. 37, No. 1, February 1998, 3GPP TS 05.08, and S. R. Saunders & A. Aragon-Zavala, Antennas And Propagation For Wireless Communication Systems: 2^{nd} Ed, Wiley, 2007.

### BACKGROUND

In many modern cities, traffic congesting is a major issue facing commuters on public roads. One solution that can ease the impact of this congestion is to provide near real-time information detailing the degree of congestion within the different segments of the road network. This may enable commuters to optimize their travel routes and times to avoid congestion as far as possible. Such traffic information is currently offered by a range of organizations spanning both the public and commercial sectors. The information used by such systems to measure the congestion may be derived from a variety of sources including dedicated infrastructure such as inductive loops installed underneath roadways and video cameras with image recognition software. Other sources include GPS measurements reported from wirelessly connected navigation devices used by travelers within the road network.

A limitation of systems requiring dedicated infrastructure is the substantial cost associated with the installation and maintenance of the infrastructure. A further limitation is the disruption to traffic caused when a sensor has to be installed or replaced, requiring a portion of the road to be taken out of service while the work is completed. It would be preferable if accurate traffic flow information could be collected across the entire road network without the need to distribute dedicated sensors and associated infrastructure throughout the network.

In certain other existing systems, position measurements are collected from users of connected navigation devices as users of those devices navigate their way through the road network. A limitation of such systems however is that only a small fraction of the users on the road at any time are using such devices. This leads to limited accuracy and/or coverage. It would be preferable if measurements for measuring the traffic conditions could be collected from a greater portion of travelers on the roads in order to achieve greater accuracy and coverage of the road network.

In yet other systems, signaling events within a cellular wireless network may be collected using probes or similar equipment. The pattern of cell to cell call handovers may be used to estimate the direction and rate of movement of the device (and corresponding vehicle). A limitation of such approaches is the need to install dedicated probe hardware in a number of locations to intercept the signaling traffic. This infrastructure brings substantial cost to achieve adequate coverage across the road network.

For the foregoing reasons, there is a need for traffic measurement systems that can operate without requiring extensive deployments of dedicated sensors and infrastructure. Furthermore there is a need for systems which can utilize the widely deployed wireless networks to obtain information to determine the traffic condition on road networks. In addition, there is a need for such systems that can obtain information from a substantial fraction of the users of the network in order to achieve a sufficient degree of accuracy and coverage as discussed herein.

### SUMMARY

Compared to existing systems, the present disclosure may provide certain advantages and/or superior systems and/or methods for collecting wireless network measurements and processing these to measure traffic flow on road networks. Improved systems and/or methods for alerting travelers to severe congestion affecting their journey ahead are also provided. Embodiments of the present disclosure are directed to systems and methods that may satisfy these needs.

According to certain embodiments, a processor-implemented method for estimating a speed of a mobile radio terminal traveling on at least one road segment is disclosed. The method is characterized by the steps of providing a road network having a plurality of nodes, each node being connected to one or more road segments, wherein the road network models a physical road topology of a geographic area; receiving a sequence of wireless measurements, wherein the sequence includes a plurality of cell identifiers; determining a route through the road network that the mobile radio terminal could have traveled based on the sequence, wherein determining the set of routes includes, selecting one or more candidate start nodes based on distance from each node in the road network to a first cell identifier in the sequence, selecting one or more candidate end nodes based on distance from each node in the road network to a second cell identifier in the sequence, determining a set of candidate routes by calculating a path through the road network for each combination of candidate start nodes and candidate end nodes, selecting a candidate route having a likelihood of being the route the mobile radio terminal traveled that is above a threshold, determining a first point on the selected route and a first time corresponding to a first cell reselection event from the sequence; determining a second point on the selected route and a second time corresponding to a second cell reselection from the sequence; and estimating a speed of the mobile radio terminal on at least one road segment between the first and second point based on a distance between the first and second point and a difference between the first and second time.

According to certain embodiments, a processor-implemented method collecting and transmitting radio communications network measurements from a mobile terminal for use in a system of estimating a traffic flow speed on road segments is disclosed. The method is characterized by the steps of accumulating a plurality of wireless measurements in a memory of a mobile radio terminal, wherein the wireless measurements include a set of cell identifiers associated with cells that previously served said mobile radio terminal; detecting a cell reselection to a new cell; if the cell identifier associated with the new cell is not in the set of cell identifiers, adding a cell identifier associated with the new cell to the set of cell identifiers, and communicating the plurality of wireless measurements to a traffic flow measurement server if a number of cell identifiers in the set of cell identifiers exceeds a threshold; and if the cell identifier associated with the new cell is in the set of cell identifiers, removing one or more cell identifiers from the set of cell identifiers, wherein the one or more cell identifiers removed include cell identifiers subsequent to a first instance of the cell identifier associated with the new cell, such that reporting of wireless measurements is minimized when the mobile radio terminal is stationary.

A system comprising a processing system and a memory coupled to the processing system is described wherein the processing system is configured to carry out the above-described methods. Computer programming instructions adapted to cause a processing system to carry out the above-described methods may be embodied within a non-transitory computer readable storage medium.

As well as the embodiments discussed in the summary, other embodiments are disclosed in the specification, drawings and claims. The summary is not meant to cover each and every embodiment, combination or variations contemplated with the present disclosure.

### BRIEF DESCRIPTION OF THE DRAWINGS

These and other features, aspects, and advantages of the present invention will become better understood with regard to the following description, appended claims, and accompanying drawings where

FIG. 1 shows an exemplary road network;

FIG. 2 illustrates an exemplary system architecture in accordance with certain embodiments;

FIG. 3 illustrates an exemplary process of classifying potential movement with physical distance showing movement in accordance with certain embodiments;

FIG. 4 illustrates an exemplary process of classifying potential movement with scale-free distance showing movement in accordance with certain embodiments;

FIG. 5 illustrates an exemplary process of classifying potential movement with physical distance showing no movement in accordance with certain embodiments;

FIG. 6 illustrates an exemplary process of classifying potential movement with scale-free distance showing no movement in accordance with certain embodiments;

FIG. 7 illustrates an exemplary spatial search for start and end nodes in accordance with certain embodiments;

FIG. 8 illustrates exemplary redundant routes in accordance with certain embodiments;

FIG. 9 illustrates an exemplary technique of estimating speed between a pair of points on the road network in accordance with certain embodiments;

FIG. 10 illustrates an exemplary technique of regular sampling to obtain serving cell observations in accordance with certain embodiments;

FIG. 11 illustrates an exemplary technique of regular sampling combined with cell reselection events to obtain serving cell observations in accordance with certain embodiments;

FIG. 12a and FIG. 12b illustrate an exemplary technique of estimating cell reselection location using predicted received signal strength in accordance with certain embodiments;

FIG. 13 illustrates an exemplary technique of estimating cell reselection location with cell reselection penalty applied in accordance with certain embodiments;

FIG. 14 illustrates an exemplary technique of estimating cell reselection location when ambiguity arises using predicted received signal strength in accordance with certain embodiments;

FIG. 15 illustrates an exemplary technique of estimating uncertainty in cell reselection location when applying uncertainty in predicted signal strength in accordance with certain embodiments;

FIG. 16 illustrates an exemplary method of collecting and transmitting radio communications network measurements from a mobile radio terminal for use in a system of estimating traffic flow speed on a road segment in accordance with certain embodiments; and

FIG. 17 illustrates an exemplary method for estimating the speed of a mobile radio terminal on a road segment in accordance with certain embodiments.

### DESCRIPTION

The present disclosure will now be described in detail with reference to one or more embodiments, examples of which are illustrated in the accompanying drawings. The examples and embodiments are provided by way of explanation and are not to be taken as limiting to the scope of the disclosure. Furthermore, features illustrated or described as part of one embodiment may be used with one or more other embodiments to provide a further new combination. It will be understood that the present disclosure will cover these variations and embodiments as well as other variations and/or modifications.

Throughout this specification, the term “mobile radio terminal” is used synonymously with terms such as “mobile phone”, “cell phone”, “handset”, “mobile station” or “user equipment” and will be understood to encompass any kind of mobile radio terminal such as a cell phone, Personal Digital Assistant (PDA), laptop or other mobile computer, or pager.

It will be understood that the term “comprise” and any of its derivatives (e.g., comprises, comprising) as used in this specification is to be taken to be inclusive of features to which it refers, and is not meant to exclude the presence of any additional features unless otherwise stated or implied.

As used herein, the term wireless measurements means a sequence, or sequences, of one or more measurements corresponding to one or more fixed wireless transceivers. The measured quantities may include parameters such as cell identifiers, received power levels, round trip delays or combinations thereof. In addition, as used herein the term cell identifier may include identifiers such as cell IDs, local areas codes (LAC), base station IDs, MAC addresses or combinations thereof. In addition, in certain embodiments the wireless measurements may include GPS location data.

As used herein, the term traffic condition means the degree to which road traffic is flowing. The traffic condition may be represented in a variety of forms such as an average speed of traffic in a certain road segment over a defined time period, as a percentage of a nominal, normal speed limit for that segment or combinations thereof. Other forms may also be used.

The present disclosure has been described with reference to certain embodiments. However, it will be apparent to those skilled in the art that it is possible to embody the inventions in specific forms other than those of the embodiments described herein. The embodiments are meant to be illustrative and not restrictive.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

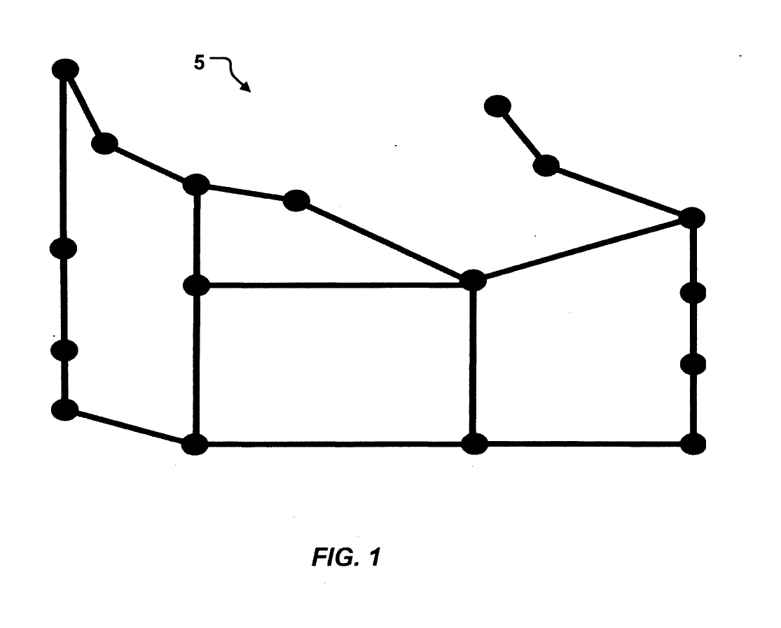

Various standards exist for representing road networks in a form suitable for use in computer-based applications. Examples of such standards are the Geographic Data Format (GDF) and the Geography Markup Language (GML). Such standards typically model road network topology as a set of nodes and a set of straight lines between these nodes, each such line referred to herein as a segment. Each such segment typically joins two nodes. Some nodes represent intersections whilst others simply join two segments as is required for a piece-wise linear model of a curved road. FIG. 1 illustrates a partially connected set of nodes and segments corresponding to a portion of a road network 5. The representation of each node includes the geographical coordinates of that node. In this illustration each node is also associated with a unique identifier. Other attributes of the road network such as speed limits, one-way streets, and turning restrictions may be represented as meta information associated with one or more nodes or segments. A route may be stated as a path from a start node to an end node along a set of contiguous road segments. Implicit in this definition is that a route has a direction of travel. Further a route typically has no repeated nodes; that is, a route has no loops. In certain embodiments the traffic condition estimates may be restricted to just major roads and as such the road network need not include the roads for which traffic flow is not being estimated. Further, as used herein, references to the road network are typically in regards to that part of the road network on which traffic conditions are being estimated. Within this disclosure reference is made to the directionality of a road segment. Such reference pertains to a road network model where the segments are non-directional and as such vehicles are assumed to be permitted to travel in either directions along such a segment. Further an arbitrary definition of directionality is applied to such segments where one of the nodes of a segment is defined as the start node and “forwards” implies movement in the direction from the start node to the other node referred to as the end node. The “reverse” direction is the direction of travel from the end node to the start node.

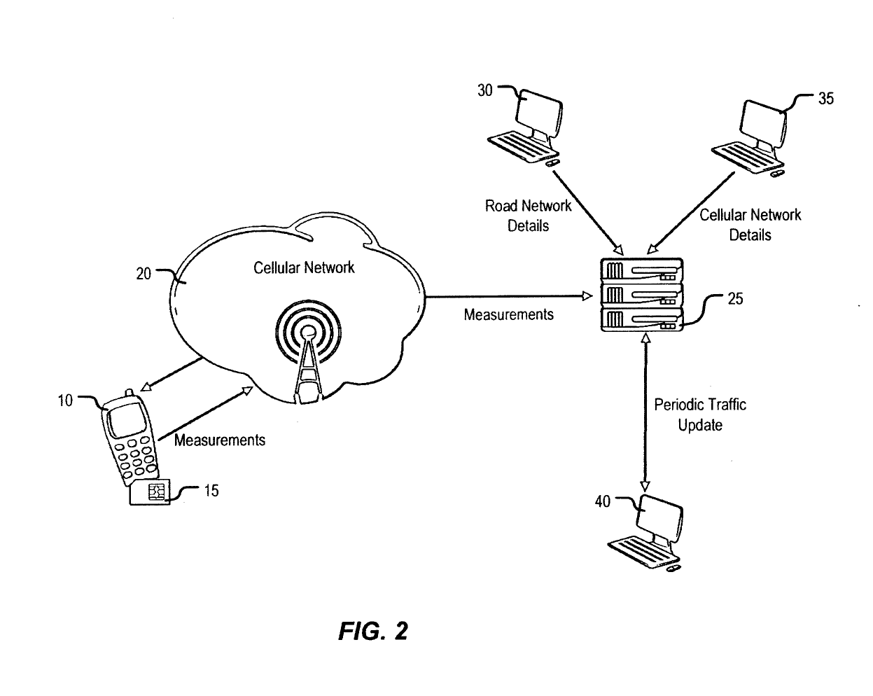

One goal of certain embodiments of the present disclosure is to estimate the speed of traffic, in one or both directions, for a subset of the road segments. Typically a subset may consist of the major roads in a region. Other subsets may be selected. Referring to FIG. 2, the speed estimates may be obtained by processing measurements obtained from one or more devices 10 within a wireless mobile network 20 (also referred to herein as a radio communications network). To enable the measurements to be obtained, the devices 10 may include a client application that gathers measurements corresponding to the wireless mobile network 20 and transmits them to a server 25 where the traffic speed estimates are computed. The server 25 may be, for example, a GNU/Linux or Apache server running on a blade server or server farm. The server 25 may also be a distributed network of servers. The server 25 may be hardware, but may also include the software.

In certain embodiments the wireless mobile network 20 may be a cellular mobile communications network such as defined in the GSM or UMTS standards. In other cases, the wireless network may consist of a number of IEEE 802.11 access points. In certain cases, multiple wireless networks may be used jointly, with client applications reporting measurements corresponding to a heterogeneous set of wireless network elements.

The client application may be embedded in the device firmware. The client application may be a device application executing within the device's operating system. In certain embodiments the client application is resident in a SIM card 15. This embodiment has the advantages of operating in a standardized manner across a large number of devices and of being secure. The device 10 obtains one or more cell identifiers (e.g., Cell ID, Local Area Code, Base Station Identify code, primary scrambling code) and also gathers measurements such as, for example, received signal strength, time of measurement (absolute or relative), frequency/channel identity.

The cell identifiers and measurements made by the device 10 are typically sent to the server 25 via the wireless network 20. For example in the case of a cellular network several services are available by which data may be transferred between a mobile device and a server. In certain embodiments the cell identifiers and measurements may be sent via SMS. In this case the measurements may be encoded in a manner that maximizes the number of measurement cycles that can be included within the 140 octets available in a single SMS. Techniques for such efficient encoding of the measurements include the use of run length encoding whereby multiple measurement cycles reporting the same serving cell are encoded as a single entry for that cell accompanied by the number of cycles it was observed. For a case where only cell IDs measurements are to be encoded, the encoded information may be described using BNF notation where + indicates accumulation, and { } indicates iteration of the item:
Report:=MCC+MNC+0{CellTableEntry}
CellTableEntry:=LAC+CID+numMeasurementCycles
numMeasurementCycles:=0.

The numMeasurementCycles field refers to the number of measurement cycles for which the cell was continuously observed. In certain embodiments the measurements may be made at regular time intervals. In certain embodiments, an event may be received by the client when there is a change in serving cell. In the interim other time events may be received enabling the client to accumulate a measure of the time for which each cell is selected as the serving cell. In such cases the number of measurement cycles may be 0 representing that the cell was selected as the serving cell for a duration less than the periodic measurement interval. The encoding of the measurement sequence reported to the server preserves the order in which the measurements were made. For example if cell A is selected as the serving cell on two occasions separated by a period serving on cell B, then there will be two entries for cell A within the reported measurement sequence, separated by an entry for cell B.

In certain embodiments the client application may be programmed to send a measurement sequence to the server on a periodic basis.

In other embodiments the client application is programmed such that a measurement report is sent whenever a sufficient number of measurements are available for reporting. When using a run length encoding scheme for example the measurement reporting may be triggered when the sequence of measured cells reaches a certain threshold. Suitable thresholds could be between 3 and 8, 5 and 8, 5 and 10, 5 and 20, 10 and 20 or 8 and 20. In yet other embodiments the criteria for triggering a measurement report could be a combination of the number of cells and a time interval so that a report is triggered if either a threshold number of cells or a interval counter is reached, whichever is first.

In yet other embodiments, the server uses measurements sent by devices for use in other applications thereby reducing the amount of SMS traffic but leaving the traffic estimation process vulnerable to a lack of data.

In certain embodiments the client application sends an updated sequence of measurements when it deems that the device may have moved. In addition to maintaining sufficient number of the immediate past measurements to fully populate an SMS, the client application maintains a list of the recently measured cells. On each change of serving cell, the client application updates both the list of measurements as well as the recently measured cell list. The update to the recently measured cell list operates in a way designed to detect movement from a starting time/position. This detection is based on the number of unidirectional cell changes. If the latest serving cell is already present in the list, then the list is ‘reset’ by removing all cells from the list that were observed after the original observation of the latest serving cell.

For example consider a list containing cells A, B, C, D, and E which were observed in that sequence. Consider further that cell C is again selected as the serving cell. The update to the list would discard all cells observed after cell C was originally measured. The updated list would contain only A, B, C. If however the latest serving cell is not already present in the list, the cell is added to the list. If the length of the list now has the threshold number of cells, then the client application reports the corresponding measurement sequence and the recently measured cell list is cleared. Consider, for example, a device stationary on a person's home. The device may choose a different serving cell from time to time but typically will not accumulate a long list of unique cell IDs, since previously measured cell IDs will recur from time to time, causing the list to be reset. This reporting approach minimizes the number of reports to the server from stationary devices, or substantially stationary devices.

The threshold is set so as to minimize the reporting of measurements from stationary devices or reduce the measurements from stationary devices to an acceptable level, since such measurements would contribute little value to the traffic measurement processing. The threshold can be determined empirically, by statistical modeling or combinations thereof. For example, an operator may experimentally determine the number of cells selected by a stationary handset at different locations within the network. In such an experiment a suitable instrumented receiver would record the set of serving cells selected over a period of time, for example 1 day. The threshold could then be set as the maximum of the number of cells seen across a selected set of experiments. In other situations the threshold could be established by using propagation modeling simulations including random noise to simulate the real world effects of fading and interference, and thus deriving the set of cells likely to be selected by a device that is stationary at a given location. This simulation could be executed over a range of locations spread throughout that part of the network that is of interest and set the threshold according to the results of the simulation. A suitable combination of experimental results and propagation modeling could also be used. The threshold can be a suitable number of measurements, such as, for example, 3, 4, 5, 6, 7, 8, 9, 10, 11, 12, 13, 14, or 15 measurements. Various ways of setting the threshold may be combined, if desired.

In certain embodiments the number of cells in the list required to trigger a sequence of measurements to be sent may be remotely configured via a configuration message sent to the client application. In certain embodiments such a configuration message would be configured according to the type of radio environment the mobile device is expected to be in. The determination of the threshold settings could be performed for each of a range of radio environments. When a sequence of measurements is received from a device, the location of that device can be estimated and compared with the network topology to determine the type of environment the device is in. An updated threshold could then be sent to the device if the threshold for the current environment is different to that currently set in the device.

Cellular networks in populated areas commonly utilize multiple directional cells. Such installations typically use three cells with the antenna bore-sights separated by approximately 120 degrees. Other variations of this set up may also be used. In some cases multiple sets of such cells are deployed for different radio-frequency bands and/or different radio access technologies. In certain embodiments, the trigger used to send a sequence of measurements is based upon the number of unique sites, as contrasted to the number of unique cells as described elsewhere in this application. When the number of unique sites observed since the last update exceeds a threshold, a measurement sequence is sent. A suitable threshold can be set using methods as described for setting the threshold for unique cell identifiers. The threshold can be a suitable number of measurements, such as, for example, 3, 4, 5, 6, 7, 8, 9, 10. In certain networks the operators have chosen to apply a numbering scheme to the cell identifiers such that it is possible to identify cells that share a common site installation based upon the cell identifiers. An example of such a numbering scheme used in GSM and UMTS networks is for the leading digits of the cell identifier to be the same for co-located cells. In such a numbering scheme cell identifiers 45321, 45322, and 45323 are at the same site installation whereas cell identifier 72311 would be at a different site installation. The device can use this pattern to determine how many unique sites have been observed in a similar manner as described for tracking unique cells. Cell identifiers modulo 10 that are the same are assumed to derive from the same site. In some networks, the numbering scheme uses the least significant digits to indicate site with the leading digit used to differentiate each cell at the site.

The transmission of the measurement sequences by one or more devices creates communication traffic within the communications network. In some embodiments, and with sufficient devices sending measurement sequences, the cumulative impact of the transmission of such sequences may adversely impact on the communications capacity available to other applications relying upon one or more components of the communications network. Alternatively, the communications load created may require additional network resources to be installed to deal with the increase communication needs, for example upgraded or additional SMSCs where the communications mechanism used is SMS. Scenarios may arise where the number of devices transmitting measurement sequences over a given time interval in a given area may exceed the number of such sequences required to establish traffic flow estimates to the desired level of accuracy.

In certain embodiments the communications requirements for the measurement sequences can be reduced by selecting specific devices to send updates at the usual rate and configuring other devices to send updates at a reduced rate, perhaps stopping updates from some devices altogether. The system retains a history of the input measurements that contribute to each traffic condition update. Such a history may contain for each traffic condition update one or more of the following: the date and time for which the traffic condition applied, identifiers for the set of devices that contributed measurements to the traffic condition estimate, and the segment or segments and direction of travel each measurement sequence contributed to. The system can inspect this history to identify the set of devices which, on average, will provide sufficient measurements to provide traffic conditions updates with the desired accuracy for the days of the week and times of the day where traffic condition estimates are required. For the devices which are not part of this set the system may send a configuration message to one or more of such devices so as to cause measurement sequences to be sent much less frequently or not at all. In one embodiment this may be achieved by increasing the period between updates. In other embodiments, this may be achieved by increasing the threshold on the number of unidirectional cell changes required before sending an update. In yet other embodiments, a combination of timer and cell changes may be used. In other embodiments, combinations of these approaches may be used. For the devices that are part of the set, the system sends a configuration message so as to cause measurement sequences to be sent with sufficient frequency.

The number of measurements required to obtain a traffic condition estimate of sufficient accuracy may be determined by various means. In some cases there may exist a portion of the road network of interest for which an alternative traffic measurement system is deployed providing a set of traffic flow data against which the systems can be compared with the aim of setting the minimum number of measurements required for each segment of the road network. A measure of the difference between the systems, or portions of the system, may then be defined as the mean of the absolute error between the traffic condition estimates and the alternative system. The sufficient accuracy is to have this measure below a certain percentage, for example below 1%, below between 2 and 5%, below between 3% and 10%, or below between 5% and 20%. By processing sets of N randomly selected measurements, and checking the result, the value of N which is expected to yield the desired accuracy is be determined. If the performance exceeds the requirement, reduce N and repeat. Similarly if performance is not good enough, increase N. The value of N is that which is smallest but which meets the performance. Other techniques for establishing N are to use radio propagation models to simulate measurement sequences along parts of the road network and then establish the value N in a manner similar to that based on real-world data.

In certain embodiments, establishing the set of devices to be enabled for the regular measurement sequence updates is performed by building up a list one device at a time based on part or all of the history of traffic condition updates. A table of data is constructed consisting of a segment ID, direction, time-of-day range, and the expected number of measurements. There is one entry in the table for each combination of segment ID, direction time range and time range. The time range is related to the system operator's intended update rate for traffic conditions. For example with a 10 minute update rate, the time of day intervals would be contiguous blocks of 10 minutes. The expected number of measurements is initialized to zero. The list of devices is initialized with the device that contributed to the most number of traffic condition updates. For each road segment ID, direction and time-of-day range, the number of updates contributed to divided by the maximum that could have been contributed to is added to the expected number of measurements for that segment ID, direction and time range. Consider, for example, a two-week history of data and that for segment ID 92 in the forwards direction, as defined for that segment, between 9:00 am and 9:15 am the device contributed to 10 updates of a possible 14. Accordingly the value 10/14 is added to the table for segment ID 92, forwards direction for the 9:00-9:15 am time range. A second device is then found to be used to update the traffic measurement table. The selection of this device is based upon the contribution it would, on average, make to the traffic flow condition for those parts of the road network which do not yet have sufficient measurements. The next device added to the traffic measurement table is that with the greatest contribution. A metric for making such selection is to count the number of traffic condition updates the device contributed to where the traffic measurement table has not yet reached the threshold of having enough measurements. Consider, for example, a two-week history of data and that for segment ID 173 in the reverse direction, as defined for that segment, between 5:15 pm and 5:30 pm the device contributed to 7 updates and between 5:30 pm and 5:45 pm contributed 3 updates. Further for the time period and between 5:30 pm and 5:45 pm, the measurement table indicates that the expected number of measurements has already been met by the devices already in the device list. Accordingly for this device, its ranking would be based on a contribution of 7 measurements. Once the device with the largest ranking is identified, the traffic measurement table is updated with the measurements from that device. The process is repeated until sufficient devices have been analyzed or the expected number of measurements has been obtained for sufficient, or each, entry in the traffic measurement table.

In certain embodiments, the selection of devices for weekends is considered separately from weekdays. In one embodiment, a set of devices is established based upon historical data for weekdays and a set of devices is established based on historical data for weekends. These sets of devices may have zero or more devices in common. In yet other embodiments, one of the sets may be first determined, and the second set building upon that first set to fill in any shortfall. For example the set required for weekday traffic condition updates is included as part of those considered for the weekend and other devices added to the overall set to make up for any shortfall for any segment ID, direction and time-of day.

Where the set of devices that regularly provide measurement sequences is controlled so as to minimize the overall impact on communications requirements, circumstances for a given traffic condition update may be such that fewer than the expected number of devices send a measurement sequence. For example, where measurement updates are triggered based on the number of unidirectional cells, heavier than usual traffic congestion could result in fewer measurement updates. It is at such times that accurate traffic flow data is more valuable. To overcome this limitation the decision process for selecting devices may be modified. In certain embodiments a given segment ID, direction and time of day may not considered to have enough expected measurements until the list of devices contribute measurements such that for every day in the set of historical data, the number of measurements matches or exceeds the minimum required to meet the target accuracy. Consider a scenario for which it was determined that 20 measurements are required to obtain the desired accuracy. Further, for historical data covering 5 days, the set of devices thus far selected contribute to road segment ID 40 in the forwards direction between 8.30 am and 8:40 am 26, 30, 12, 43, and 36 measurements respectively. This data indicates a potential for too little data on day 3 and the next candidate device which contributed measurements to that segment ID 40 in the forwards direction between 8.30 am and 9.30 am on the third day would be added to the device list.

In other embodiments, the minimum expected number of measurements required is set as a multiple of the actual number required to meet the targeted accuracy. Such a multiple could be in the range of, for example, 1.0-2.0, 1.5-3.0, 2.0-5.0, 3.0-10.0, 5.0-20.0, or 10.0 to 100.0. For example if the number of measurements required to meet the targeted accuracy was 15 and the multiplier was 1.5, then the threshold for the expected number of measurements for a given segment ID, direction and time of day range would be 22.5.

In certain embodiments the control of devices may be adjusted on a time of day basis. In certain embodiments the control of devices may be adjusted on a time of day of week basis. In certain embodiments the control of devices may be adjusted on a time of day basis and day of week basis. Consider a device observed to consistently contribute to traffic condition estimates on specific segments of the road network on Mondays through to Thursdays but for Friday through Sunday does not consistently contribute to any traffic condition updates. For such a device, as could arise from a person working 4 days a week at the same location, the system may send a configuration message on Monday mornings to enable regular measurement sequence updates and another message on Thursday evening to reduce the update rates or disable them.

The system estimates traffic speeds for both directions of each road segment separately. The sequences of measurements reported by devices over a given period are processed to obtain an estimate of the traffic flow speeds for each road segment and direction for that period. In certain embodiments the update period may be a fixed interval. The update period may be configurable such as via a management interface to the system. In certain embodiments the update period may also be adapted to the number of measurements received since the traffic flow estimates were last updated. That is, the greater the rate of incoming measurement sequences, the more frequently the traffic flow estimates are updated. The effective update period may be determined by a combination of a minimum number of measurement sequences or an elapsed time whichever is reached first. Update periods may be, for example, in the range 30 secs to 5 mins, 1 min to 10 mins, 5 mins to 30 mins, or 10 mins to 1 hour.

The traffic modeling process employs a model of the road network. In certain cases, the traffic processing may be targeted to only a subset of the traffic bearing roads in the network. As an example, the processing may be focused only on major arterial roads. In this case a complete model of the road network may be provided together with an indication of the subset of road segments on which to estimate traffic flow speeds. Alternatively a partial road network model may be provided, containing only those roads for which speed estimates are required. Such road network data could be obtained from a third party source and manually loaded via a management interface. Such road network data could be configured to be regularly updated from a third-party source of road network data.

In certain embodiments, the traffic modeling process requires information on the topology and configuration of the wireless network or networks from which devices will be making measurements. By way of illustration, if the wireless network is a cellular mobile communications network, such data may include one or more of the cell identifiers (e.g. Cell ID, Local Area Code, Base Station Identify code, and/or primary scrambling code), radio access technology (GSM, IS95, UMTS, CDMA-2000, AMPS), transmit power level, frequency/channel identity/RF Band, antenna pointing angle, antenna height, antenna beamwidth, antenna type (macro cell, micro cell, pico cell, femto cell, underground cell), and coordinates. Such cellular network data could be obtained from the cellular network operator and manually loaded via a management interface. Such cellular network data could be configured to be regularly updated from a database maintained by a cellular network operator. Such cellular network data might alternatively be obtained from a system which estimates the cellular network topology and configuration based on field observations of that cellular network. As another example, if the wireless network is comprised of a number of IEEE 802.11 access points, the configuration information may include the MAC address and geographic coordinates where the device/antenna is situated.

The traffic speeds are estimated via a combination of one or more of the following processes, each of which is described in more detail below:
Identifying which measurement sequences derive from devices likely to be moving along a road
Identifying one or more routes through the road network that could potentially have given rise to a given measurement sequence
Refining the set of potential routes that could have given rise to a given measurement sequence
Selecting a subset of the measurement sequences where only part of the sequence is deemed to be consistent with movement along a route of interest.
Estimating the speed at which the device traversed one or more road segments based on a given measurement sequence, and the uncertainty associated with the estimated speed
Combining multiple speed and associated uncertainty estimates to derive an overall speed and uncertainty of speed estimate for one or more road segments in one or both directions.

The output of the system may be an average speed and associated uncertainty for one or more road segments of interest and in one or more directions. There are many ways in which this data may be provided. These include:
Textual representation of the estimated speed values
Binary representations of the estimated speed values, provided via a digital interface to a secondary system
Instructions for rendering the speeds on a graphical display via a third party system. An example of such instructions are the Keyhole Markup Language (KML)
A bitmap containing a rendered image of the road network with traffic flow indicated via a colour range; for example green graduated through to red indicating no congestion through to heavy congestion
Alerts sent to users registered to receive information on particular roads. In particular such an alert may only operate when traffic speeds drop below a certain value.

To estimate traffic flow, the measurements of interest are those that derive from devices deemed to be moving within the road network. Data from stationary devices typically contributes little to the traffic flow estimates. Certain exceptions may apply, for example, devices rendered stationary due to traffic congestion. System performance can be improved by discarding measurement sequences reported from devices that have not moved sufficiently far to be deemed to be in moving vehicles.

Consider a sequence of serving cells reported by a device. On average, devices in motion will tend to report sequences that include a number of unique cells. As such, one basis for identifying sequences suspected of being stationary is to apply a threshold for the number of distinct cells that need to be represented in the sequence. Sequences that contained too few unique cells may then be ignored. While such an approach will cull data from some stationary devices, there may still be stationary devices reporting cell sequences with sufficient unique cells. The nature of interference and fading in mobile radio networks means that stationary devices can in certain circumstances select many different serving cells over a period of time.

To provide further discrimination between moving and stationary devices, information on the geographic positions of the transmitters corresponding to the identifiers can be exploited. Consider a sequence of serving cells A, B, C, D, E reported by a mobile cellular device. The processing to determine whether the measurement sequence reported is consistent with a moving vehicle on the road network can calculate a spatial distance corresponding to the sequence from cell A to cell E. The sequence is considered a candidate for inclusion in the traffic flow estimation process if the calculated distance exceeds a threshold. The non-uniform spatial distribution of cells in a typical cellular network however makes such a purely distance based threshold unreliable. For example a threshold of 10,000 m would serve to indicate movement in an urban area where cells are relatively close. In a rural setting, however, a single cell reselection by a stationary device could correspond to a distance of for example 10,000 m. To overcome this problem in certain embodiments the distances corresponding to the cell reselections may be normalized with respect to the cell site spacings.

In certain embodiments an attribute associated with each cell in the wireless network configuration information is a radius value representing the scale of the area covered by each cell. For omnidirectional cells, the coverage area may typically be approximated as a circle centered on the corresponding base station with the specified radius. For directional cells the coverage area may be approximated as a sector of a circle aligned with the cell's pointing angle and centered on the base transceiver station (BTS) with the specified radius. Cell radius values may be obtained from sources such as radio network planning tools, field measurement data, or may alternatively be estimated based on the distance to nearby cell sites.

To compute a distance corresponding to a sequence of N serving cells reported by a device, the processing is as follows. The scale-free vector ΔDi from the ith cell in the sequence to the (i+1)th cell is given by

$$\begin{matrix}Δ D = {\sum }_{i = 1}^{N - 1} Δ {D}_{i} \\ = [ \begin{matrix}Δ {d}_{x} \\ Δ {d}_{y}\end{matrix} ] \\ D = \sqrt{Δ {d}_{x}^{2} + Δ {d}_{y}^{2}}\end{matrix}$$

Where X corresponds to a cell centroid and r is a radius value representing the scale of the area covered by a particular cell.

For the entire sequence the scale-free distance metric, D, is the sum of the scale-free distance between the cells:

$$X = [ \begin{matrix}x \\ y\end{matrix} ]$$

In certain embodiments, an attribute of each cell, or sufficient cells, in the cellular network model is the coverage area. The model for this area is an ellipse approximating the area where the cell is likely to be observed by mobile devices as the strongest cell. The size and orientation of the ellipse may conveniently be represented by a diagonally symmetric 2×2 matrix. An example of modeling the area of cells with ellipses is disclosed in PCT/AU09/000,436. Such an ellipse may be found by using propagation modeling techniques to find points where the cell in question is received more strongly than other cells and to then find the two-dimensional spread of these points. By treating this ellipse as a two-dimensional probability density function (PDF), a scale free distance metric can be defined using the Mahalanobis distance. For a given cell the centroid X is a coordinate vector

$$C = [ \begin{matrix}{σ}_{x}^{2} & {σ}_{xy} \\ {σ}_{xy} & {σ}_{y}^{2}\end{matrix} ]$$

The size and orientation of the ellipse as a covariance matrix is

$$\begin{matrix}Δ {X}_{i} = {X}_{i + 1} - {X}_{i} \\ = [ \begin{matrix}Δ {x}_{i} \\ Δ {y}_{i}\end{matrix} ]\end{matrix}$$

Consider a sequence of N serving cells reported by a device. The scale-free vector ΔDi from the ith cell in the sequence to the (i+1)th cell is given by

$$\begin{matrix}Δ {X}_{i} = {X}_{i + 1} - {X}_{i} \\ = [ \begin{matrix}Δ {x}_{i} \\ Δ {y}_{i}\end{matrix} ] \\ {M}_{i} = Δ {X}_{i}^{T} {C}_{i}^{- 1} Δ {X}_{i} \\ Δ {D}_{i} = \frac{Δ {X}_{i}}{{‖ Δ {X}_{i} ‖}_{2}} {M}_{i} \\ {‖ Δ {X}_{i} ‖}_{2} = \sqrt{Δ {x}_{i}^{2} + Δ {y}_{i}^{2}}\end{matrix}$$

Where all operations are vector/matrix operations, the −1 superscript is the matrix inverse, the T superscript denotes the matrix transpose, and Mi represents the Mahalanobis distance.

For the entire sequence the scale-free distance metric, D, is the sum of the scale-free distance between the cells:

$$\begin{matrix}Δ D = {\sum }_{i = 1}^{N - 1} Δ {D}_{i} \\ = [ \begin{matrix}Δ {d}_{x} \\ Δ {d}_{y}\end{matrix} ] \\ D = \sqrt{Δ {d}_{x}^{2} + Δ {d}_{y}^{2}}\end{matrix}$$

A suitable threshold for classifying whether a given measurement sequence suggests movement of the corresponding device along the road may be in the range 0.5-3, or 2-10, or 5-20.

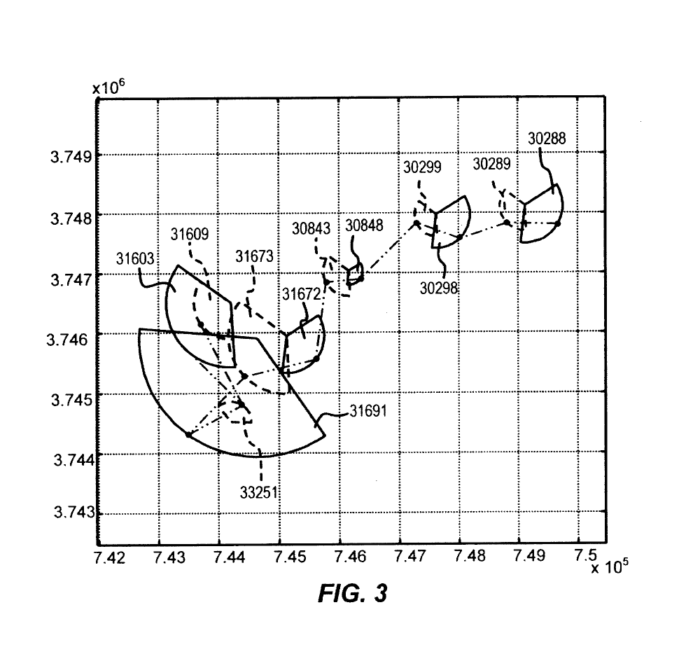

FIG. 3 illustrates the geographical location of cells corresponding to a sequence of measurements: 30288, 30289, 30298, 30299, 30848, 30843, 31672, 31673, 31691, 33251, 31603, 33251, 33251, and 31609. Each cell is represented as a sector of a circle. The cells are shown alternately in solid and dashed line only for purpose of differentiation. The origin of a sector corresponds to the location of the corresponding cell BTS and the radius represents the estimated range of each cell. The dash two dot straight lines correspond to consecutive cells in the measurement sequence and join the respective estimated centroids of the areas served by each cell. The coordinates in the plots are eastings and northings and hence represent distance in metres. The grid spacing is set to 1000 m. The distance from the start cell to the end cell, noting that some lines are covered twice due to repetition in the cell sequence, is 6.2 km.

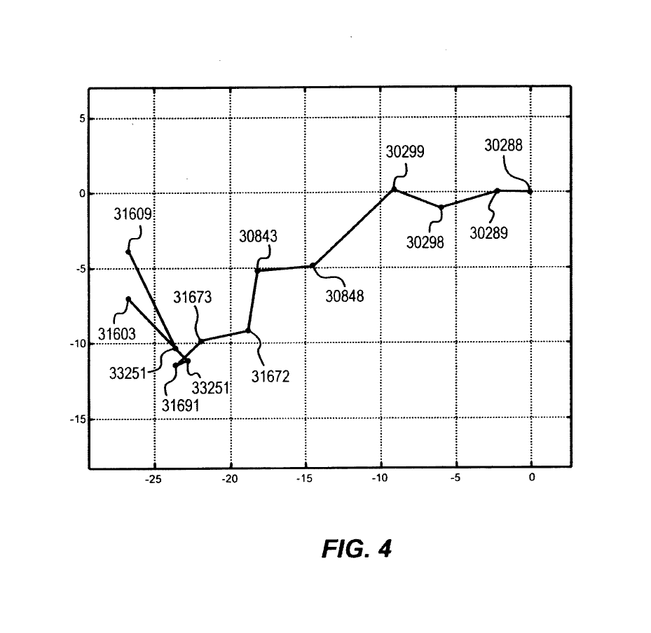

FIG. 4 illustrates the calculation of the scale-free separation for the same cell sequence as used in FIG. 3. The scale-free metric used is the Mahalanobis distance. The scale-free distance from the start cell to the end cell is 27.0. Using an example threshold of 10, this sequence of cells would be considered to indicate movement of the corresponding mobile device.

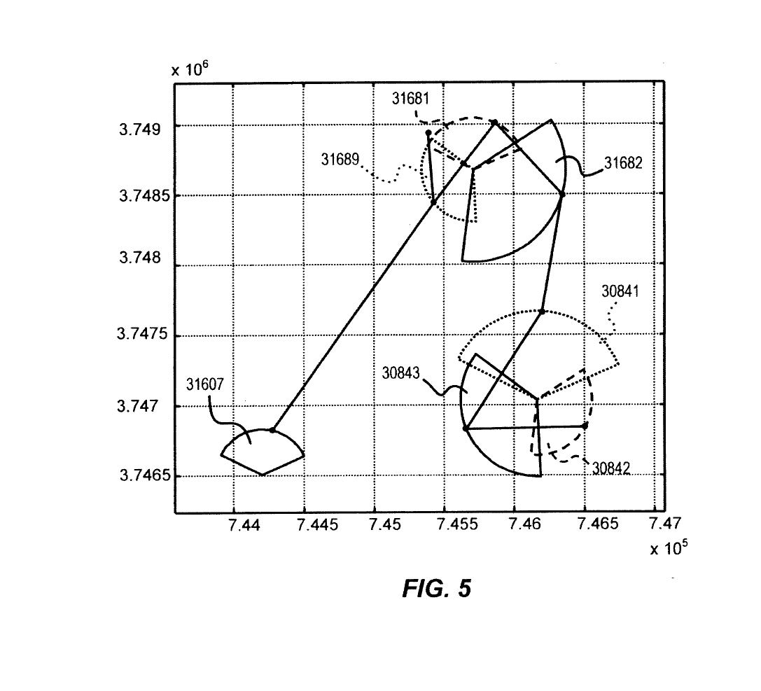

FIG. 5 illustrates the geographical location of cells corresponding to a second sequence of measurements: 30843, 30842, 30843, 30841, 31682, 31681, 31689, 31607, 31689, and 32697. The cells are shown alternately in solid, dashed, and dotted line only for purpose of differentiation. Cell 32697 is hidden for clarity. The distance from the start cell to the end cell in this case, noting that some lines are covered twice due to repetition in the cell sequence, is 2.12 km.

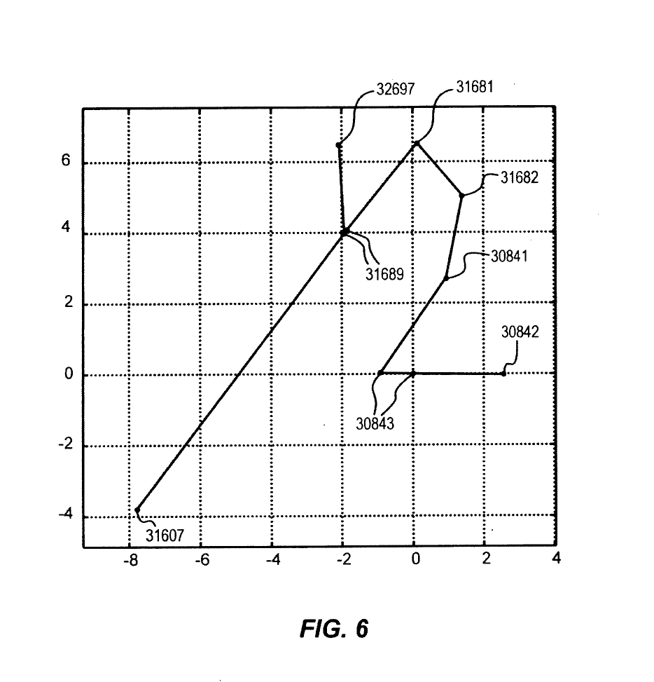

FIG. 6 illustrates the scale-free separation for the same cell sequence as used in FIG. 5. The scale-free metric used is the Mahalanobis distance. The scale-free distance from the start cell to the end cell is 6.8. Using an example threshold of 10, this sequence of cells would not be considered to indicate movement in this application.

A given vehicle can only travel a single route through the road network over a given period of time. An aspect of processing to estimate traffic flow is to determine which route a given vehicle is likely to have followed, based on the set of measurements reported by the device. Given such a route the sequence of observed cells can then be used to estimate the speed at which the device traveled along that route. In certain embodiments all, or sufficient, possible routes, or a subset of reasonably likely routes, are determined and for each such route the speed along each of these routes is estimated. Ultimately the most likely route is determined and the corresponding speed estimates associated with that route are used. In an embodiment, the server 25 first identifies a subset of all, or sufficient, possible routes and then only estimates the speed for that subset. This embodiment has the advantage of being more computationally efficient by avoiding the unnecessary estimation of speeds on possible routes for which it is unlikely that the vehicle could have traveled along.

In certain embodiments, the computational load can optionally be reduced by identifying a set of possible routes based on the first and last cells in the sequence within the location request update. A spatial search is used to identify a candidate set of start and end nodes within the road network. The spatial search metric could be used to find all, or sufficient, road network nodes within a specified distance of the start/end cell in the sequence. As discussed elsewhere in this application using Euclidean distance is problematic due to non-homogeneous cell site density across typical cellular networks. A more suitable scale free metric may be used instead, as described elsewhere in this application, whereby the Euclidean distance is scaled by a factor proportional to the cell spacing such as the cell radius. In the preferred embodiment the Mahalanobis distance is used. A set of candidate start nodes is found by finding all, or sufficient, nodes in the road network within a threshold Mahalanobis distance from a position corresponding to the start cell and similarly for the end cell. The position chosen corresponding to a given cell may be the base station site or may alternatively be the estimated centroid of the coverage area for that cell. When using the Mahalanobis distance as the metric, a suitable threshold may be in the range of, for example, 0.5-3, 1-4, or 2-10. Determining the threshold is based on the trade-off of having too many routes to consider versus there being no nodes within the threshold Mahalanobis distance. In certain embodiments a value of, for example, 3 will result in there being at least one node so selected. Where there are long straight roads modeled simply by the start and end node, then a larger threshold may be needed. Alternatively such long straight nodes could be remodeled into a series of shorter straight segments resulting in nodes lying within the threshold Mahalanobis distance.

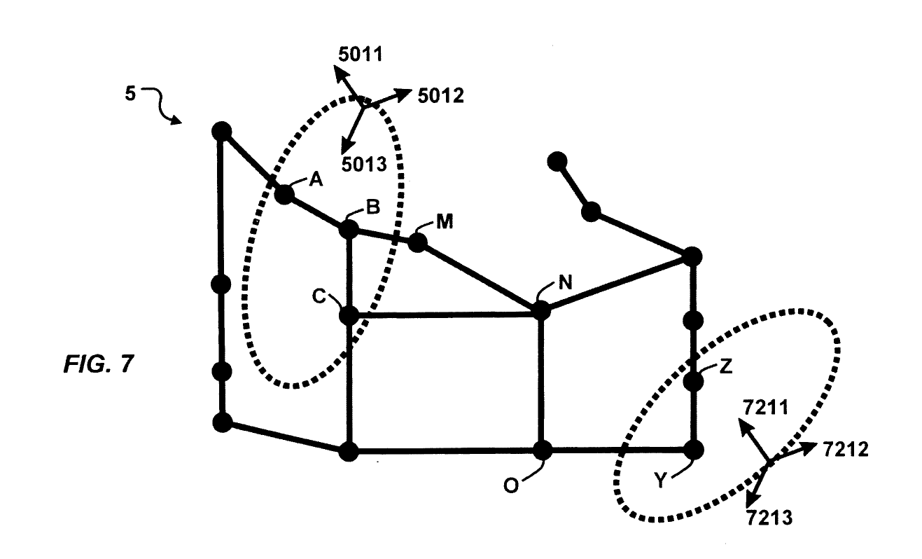

As an example, consider the scenario in FIG. 7 showing exemplary road network 5 in which cell 5013 is the first (oldest) cell in a measurement sequence and 7211 is the last (newest) cell in a measurement sequence. Nodes A, B, and C lie within the coverage area of cell 5013 as modeled by the ellipse which represents the limit for a given Mahalanobis distance threshold. As such nodes A, B, and C form the set of candidate start nodes. Similarly for the coverage of cell 7211 for which nodes Z and Y are within the Mahalanobis distance threshold and as such form the set of candidate end nodes.

Optionally the initial spatial process can also be used to trim the sequence of cell measurements to that set likely to have derived from those parts of the road network where traffic flow is to be estimated. Typically, traffic flow estimation may be focused on major roads, with minor/residential streets being ignored. Consider a device that has just departed from a suburban residence. The initial cell measurements made by that device may not pertain to a road of interest for traffic flow estimation. Similarly towards the end of the journey the device may depart from a major road in order to reach the destination. The minor roads taken at the end of the journey may not be of interest for traffic flow estimation. The computation load of the system and the robustness of the traffic flow estimates can be improved by removing from the estimation process those measurements that are unlikely to pertain to a road of interest.

To do this, an exemplary processing technique is as follows. The first, oldest, measurement within the measurement sequence is compared to the road network. If the nearest point on any of the roads of interest is too far away, the measurement sequence is trimmed to remove that measurement. The process is repeated until the first measurement in the sequence is sufficiently close to a road of interest. Similarly for the last, most recent, measurement in the sequence until the first and last measurements in the measurement sequence are both sufficiently close to the road network. Various criteria for defining “sufficiently close” may be used. As described elsewhere in this application distance measurements present problems due to the varying cell spacing within typical cellular wireless networks. Certain embodiments employs a scale free metric, as described elsewhere in this application, whereby the Euclidean distance is scaled by a factor proportional to the cell spacing such as the cell radius, or a scale-free metric such as the Mahalanobis distance is used. If the scale free distance from the start or end of the sequence exceeds a threshold, that cell is trimmed from the measurement sequence. Once the measurement sequence is trimmed, the identification of candidate set of start and end nodes are created as described elsewhere in this application. When using the Mahalanobis distance as the metric, a suitable threshold may be in the range 0.5-3, 1-4, 2-10.

A set of candidate routes for the cell sequence is then created by finding the routes for each pairwise combination of candidate start and end nodes. In certain embodiments, the server 25 determines this set of routes by creating all of the pair-wise combinations of start and end nodes. In certain embodiments, for each such pairing, the server calculates the shortest route through the road network from the start node to the end node. Algorithms for finding such routes are well known in the art and include algorithms such as Djikstra's algorithm and the A* algorithm. In other embodiments, the server may select a route based on, for example, the highest probability route between the start and end nodes within the candidate set of routes from historical traffic patterns. Within this set of routes there may exist some routes that are sub-routes of another route, that is the sequence of nodes that comprise the route exist in one or more other routes. Such routes are here considered redundant and as such maybe removed from the set to minimise computation.

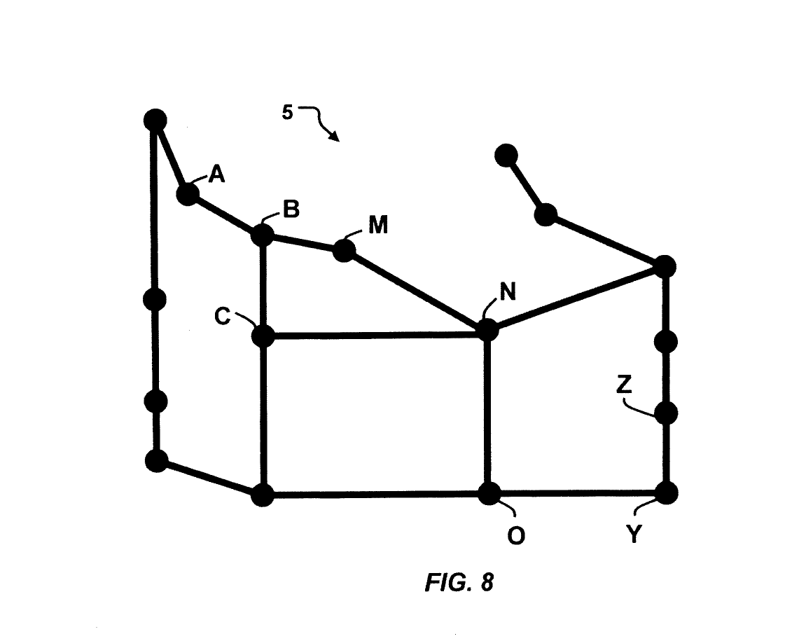

As an example consider the set of candidate start nodes A, B, C and candidate end nodes Y, Z as shown in FIG. 8 showing exemplary road network 5. There are six candidate routes formed by A-Y, A-Z, B-Y, B-Z, C-Y, and C-Z. The route for A-Z would traverse nodes ABMNOYZ. Consider the route B-Y which is BMNOY. This route is entirely encompassed within the candidate route for A-Z and as such is considered redundant and deleted. Similarly for other candidate routes including A-Y and B-Z.

The candidate routes for a given sequence of measurements are compared against the measurement sequence to determine the route or routes which the device most likely traveled along. This is achieved via a metric that quantifies the likelihood that the sequence of measurements could have arisen from a vehicle driving along the candidate route. One such metric is to sum the distances from a point corresponding to each cell in the measurement sequence to the nearest point on the route. As discussed elsewhere in this application, setting a threshold for such a metric is affected by the non-homogeneous spacing of cell sites in typical cellular networks. In the preferred embodiment a scale free distance metric is used which is the Mahalanobis distance. The Mahalanobis distances Mi from each cell in the measurement sequence to the nearest point Pi on the route R to centroid Xi of the coverage ellipse with covariance Ci are summed. This sum may be considered as a chi-squared statistic with the number of degrees of freedom equal to the number of measurements in the sequence N and is computed by:

$$\begin{matrix}{P}_{i} = {arg min}_{P} ( {‖ {X}_{i} - P ‖}_{2} ) , P ∈ R \\ {‖ {X}_{i} - P ‖}_{2} = \sqrt{{( {x}_{i} - {x}_{p} )}^{2} + {( {y}_{i} - {y}_{p} )}^{2}} \\ Δ {X}_{i} = {X}_{i} - {P}_{i} \\ = [ \begin{matrix}Δ {x}_{i} \\ Δ {y}_{i}\end{matrix} ] \\ {M}_{i} = Δ {X}_{i}^{T} {C}_{i}^{- 1} Δ {X}_{i} \\ {χ}^{2} = {\sum }_{i = 1}^{N} {M}_{i}\end{matrix}$$

A candidate route may be deemed to be sufficiently consistent with the observed sequence of measurements if the cumulative probability corresponding to the computed chi-squared statistic is below a threshold. The cumulative probability may be obtained by using published tables, numerical approximations, or other means well known in the art. Suitable threshold values may be in the range 0.5-0.9, 0.75-0.95, 0.8-0.99. Setting the threshold involves a compromise between associating a measurement sequence with a route that was not traveled and hence introducing erroneous data into the traffic flow estimation process, and on the other hand, failing to associate the measurements with the correct route and consequently losing the value such measurements would add to the next traffic flow update. The choice of a suitable threshold is affected by a number of factors including the relative position and orientation of cells to the road network and the proximity and orientation of other road segments. In certain embodiments, setting the threshold may be performed by travelling parts of the road network of interest for traffic condition estimation whilst carrying one or more devices which collect and report measurements of the wireless network. Since the correct route is known, the data collected from the device(s) can be processed to compute the set of candidate routes and then determine which of these candidates would be selected for a given threshold value. The test can be conducted a number of times and the threshold chosen such that the accuracy of the estimated traffic condition as compared to the true traffic conditions is maximized. Such true traffic condition data can be obtained from other traffic flow sources or can be obtained by using a location device such as GPS when travelling the chosen parts of the network. In other embodiments, an operator could set up a similar experiment but instead of measurements from devices, simulate the journey along one or more routes and simulate the measurements a device travelling such a journey would make and then process the resulting data as per the experiment described for actual measurements.

As an example, consider a sequence of 6 measurements for which the chi-squared statistic on a candidate route is computed to be 13.27, corresponding to a cumulative probability value of approximately 0.961. Using a threshold set at 0.99, the candidate route would be accepted as sufficiently consistent with the measurements. Had the threshold been set at 0.95 however, the candidate route would be rejected as not sufficiently consistent with the measurements.

In some instances none of the candidate routes may be deemed sufficiently consistent with the measurements. When this occurs, the sequence of measurements is not processed any further and the measurement sequence makes no contribution to the overall traffic speed estimates.

In certain circumstances the route identification algorithm described here may yield more than one route with a metric indicating sufficient consistency with the measurements. In such cases all candidate routes are processed with the given sequence of measurements as though each candidate route was the only candidate. At most one of these candidate routes will be the correct route. The incorrectly identified routes will introduce errors into the speed estimation process. However, the process of creating an overall speed estimate for a given section of road, described subsequently in this application, provides a degree of robustness against this type of error.

Given a sequence of measurements and a candidate route selected as being sufficiently consistent with the measurements, speed estimates can then be generated for one or more road segments and directions on that route. In practice, the speed of a vehicle along a route may vary significantly from one road segment to the next. A particular example is traffic being congested leading up to an intersection but free flowing on the other side of the intersection. As such it may not necessarily be appropriate to obtain a single speed estimate for the entire route. To do so would imply an assumption of constant speed along the route. In the preferred embodiment the sequence of measurements is analyzed with respect to the road network and partitioned into an ensemble of measurement sub-sequences. Each such partition is then used to estimate speed for one or more segments on the candidate route as though that partition was an independent measurement sequence.

In certain embodiments a sequence of N measurements may be partitioned simply by breaking up the sequence into sub-sequences such that each measurement from the original N measurements is present in only 1 of the partitions. In the preferred embodiment, the partitions may overlap with other partitions with the implication that a given measurement may be present in more than one partition. Consider a sequence of 20 measurements. This may be partitioned into 8 measurement sequences using measurements 1-6, 2-8, 4-9, 5-12, 6-13, 8-15, 10-16, and 17-20.

In a preferred embodiment, speed estimates are computed between events corresponding to a change in serving cell, also referred to as a cell reselection. Such events will have, as a minimum, identifiers associated with the two cells involved and a corresponding absolute or relative timestamp. Where the original observations contain serving cell and an indication of time, relative or absolute, then an equivalent set of cell reselection measurements can be readily derived. A cell reselection event arises when any pair of adjacent serving cell observations correspond to different serving cells. The time of occurrence of such a reselection is deemed to be at a point in time, relative or absolute, half-way between the two observations. The uncertainty this process introduces into the speed estimate is addressed subsequently in this application.

One primary aim of this partitioning is minimize the error in the speed estimates. One source of error in the speed estimates arises from the errors in the estimated reselection locations. Since the speed is calculated by dividing the distance between reselections by the time between reselections, the effect of this error due to the reselection positions may be minimized by increasing the denominator (the time between reselections), in other words choosing a longer measurement sequence.

A different type of error however may arise due to non-constant velocity of the vehicle along the road. The greater the length of the cell sequence used to compute a speed estimate, the greater the chance that the vehicle slowed or accelerated within the interval.

Therefore it is necessary to choose partitions having lengths which balance these two sources of error. The optimal sequence length will depend on several factors, including the type of road. In urban areas where road segments include traffic lights, the likelihood of non constant velocity is greater than on major highway sections. Accordingly, smaller partitions, corresponding to shorter intervals may be yield more accurate results. In certain embodiments partitions may be selected such that the interval corresponds to about 1 minute or between 45 seconds and 2 minutes or between 90 seconds and 4 minutes.

In the preferred embodiment, the candidate routes are obtained for a measurement sequence and then the measurement sequence is partitioned and each resulting measurement partition is applied to the route, or part thereof. In alternative embodiments, the measurement sequence could be first partitioned and then each such partition used to identify candidate routes and then to estimate the speed for each such route using that partitioned measurement sequence.

Within the context of estimating speed, references to a measurement sequence include a measurement sequence that has derived from the measurement partitioning process. A speed estimate is computed for a route in the road network by estimating the location along the route where the serving cell change occurred for the first (oldest) to the second cell in the sequence and by estimating the location along the route where the serving cell change occurred for the second last to the last (oldest) cell in the sequence. The speed estimate is then computed by calculating the distance along the route between the two-estimated positions divided by the estimated time taken. This speed estimate is then associated with each road segment along the route between the two points and includes the road segments on which the two points lie. When all, or sufficient, measurement sequence partitions from one or more measurement sequences are processed, each road segment and direction will have one or more speed estimates which are then combined to derive an overall speed estimate for each road segment and direction.

A consequence of the overlapping partitions is that a given measurement may contribute to more than one speed estimate for a given road segment and direction. Such cases may contribute correlated observations into the set of speed estimates for a given road segment and direction. This correlation is addressed by the processing approach applied to the combined measurements, described subsequently.

As described in more detail herein, the processing of the observations of serving cells selected by the device produces a pair of position estimates x1 and x2 on a specific route within the road network. The distance along the route from x1 to x2 is denoted d.

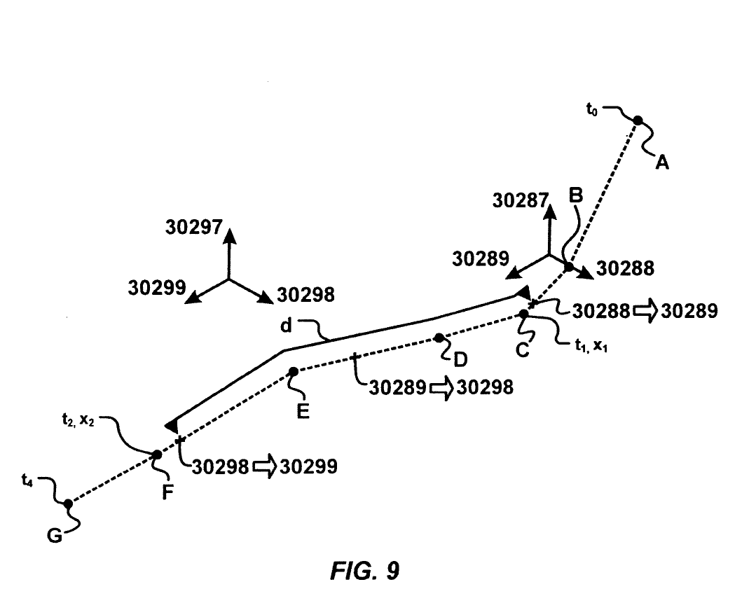

An exemplary process for estimating speed on a route having multiple road segments is shown in FIG. 9. FIG. 9 illustrates speed estimation for a scenario in which a mobile radio terminal traveling along the route obtained a sequence of measurements (which corresponds to a partition in this example) including 3 cell reselection events denoted: 30288->30289, 30289->30298, and 30298->30299. The partition begins at time t₀, which is indicated on FIG. 9 to show the corresponding location of this first measurement. The first and last reselection in the partition (i.e., 30288->30289 and 30298->30299) occur at times t₁ and t₂, and the end of the partition occurs at time t₄. The route is represented using dashed lines with the filled in circles as nodes. The road segments connect the nodes, and are referred to as AB, BC, CD, DE, EF, and FG. The lines with arrows indicate the cell location and pointing angle of the antennas. Based on the sequence of measurements, the system determines the estimated locations for the cell reselections, which are marked with a + symbol. The location of 30288->30289 corresponds to x₁ and 32098->30299 corresponds to x₂. The distance d as measured between these points is measured along the road. The resulting speed estimate would be associated with the segments between nodes BC which contains x₁, CD, DE, which are fully traversed, and EF which contains x₂.

Associated with each of the points x₁ and x₂ is a one dimensional uncertainty, denoted σx₁ and σx₂ respectively, corresponding to displacement along the selected route. Typically the uncertainty will represent a standard deviation. The uncertainty in the two reselection position estimates results in a corresponding uncertainty in d. If the position uncertainties are expressed as standard deviations then the uncertainty in the distance, denoted σd is given by

σ_{d}=\sqrt{σₓ₁²+σₓ₂²}

Also obtained from the measurement sequence is an estimate of the time taken to travel from x1 to x2, denoted t, or absolute times t1 and t2 from which t can be computed as t=t2−t1. In some embodiments the source of the time measurements may be inaccurate and this uncertainty is represented as an uncertainty σt in the case of having a travel time or σt1 and σt2 where the times are absolute. In the case where absolute times are provided, σt can be computed as

σₜ=\sqrt{σₜ₁²+σₜ₂²}

The estimate of the vehicle's speed, denoted v, from x1 to x2 is

$$v = \frac{d}{t}$$

d is the distance between x1 and x2 as measured along the segments of the road network.

The uncertainty in the position estimates and in the travel time results in a corresponding uncertainty in the speed estimate denoted σv. The general formulation for estimating the uncertainty σ in a quantity computed as function ƒ of two uncertain quantities x and y is:

$${σ}^{2} = {{σ}_{x}^{2} ( \frac{\partial f}{\partial x} )}^{2} + {{σ}_{y}^{2} ( \frac{\partial f}{\partial y} )}^{2}$$

Applying this to the speed estimate

$${σ}_{v}^{2} = \frac{{σ}_{d}^{2}}{{t}^{2}} + \frac{{σ}_{t}^{2} {d}^{2}}{{t}^{4}}$$

In certain embodiments the serving cell observations are obtained by using a regular sampling interval. An example of such an embodiment is the Proactive Timer Management functionality in a SIM card supporting the Card Application Toolkit (CAT) standard (ETSI TS 102 223), also known as the SIM Toolkit (STK). Denote the period of the sampling interval Ts. Consider such a sample sequence where on sample M the serving cell is cell A (e.g., 32088 from FIG. 9) and on sample M+1 the serving cell is cell B (e.g., 32089 from FIG. 9). The position estimate x1 derives from a process that estimates where the device reselected cell B having been on cell A. The actual cell reselection event occurred at some time between samples M and M+1 meaning that there is an uncertainty in the actual time the cell reselection occurred. The uncertainty associated with cell reselection time can be modeled as a uniform PDF resulting in

$${t}_{1} = ( M + \frac{1}{2} ) {T}_{s}$$

$${σ}_{t 1}^{2} = \frac{{T}_{s}^{2}}{12}$$

The speed estimate is to be evaluated using a second cell reselection from cell E to cell F which occurred sometime between sample N and N+1. Accordingly the cell reselection time and uncertainty are

$${t}_{2} = ( N + \frac{1}{2} ) {T}_{s}$$

$${σ}_{t 2}^{2} = \frac{{T}_{s}^{2}}{12}$$

And

$$t = ( N - M ) {T}_{s}$$

$${σ}_{t}^{2} = \frac{{T}_{s}^{2}}{6}$$

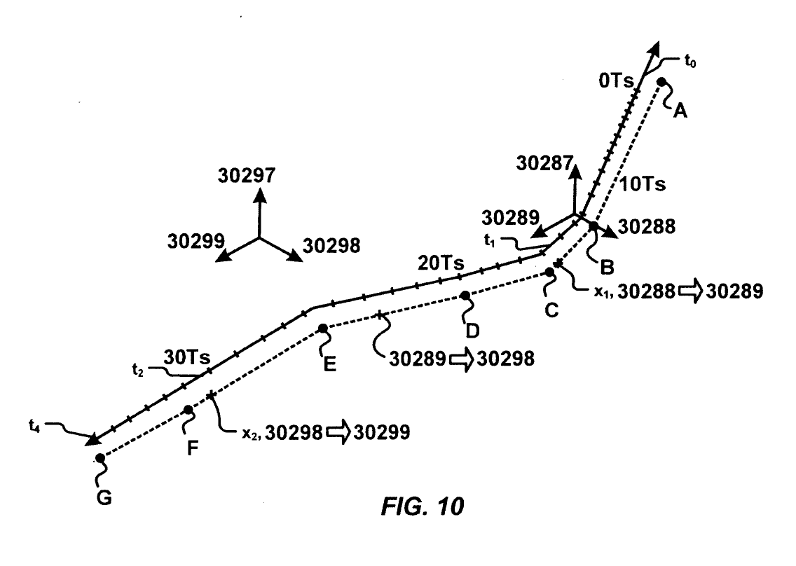

FIG. 10 illustrates the regular sampling to obtain observations of the serving cell as currently selected by the cellular mobile device. The speed is to be estimated from the cell reselection event from 30288 to 32089 and the later reselection from 30298 to 30299. The serving cell was changed from 30288 to 30289 at some instant between the time of the 16^{th} and 17^{th} sampling event at times 15 Ts and 16 Ts respectively. Accordingly t1, the time of the reselection event is set to 15.5 Ts. Similarly for the reselection from 30298 to 30299 which occurred between the 31^{st} and 32^{nd} sample at times 30 Ts and 31 Ts respectively. Accordingly t2 is set to 30.5 Ts. The total time is 15 Ts.

In certain embodiments, the serving cell observations are obtained by a combination of time events and cell reselection events. An example of such an embodiment a SIM card supporting the CAT using the Status Polling event to obtain fixed-interval timer events and the Event Download—Location Status (refer to ETSI TS 102.223) event to be notified of serving cell reselections. The timer events are of a fixed interval Ts but of a configurable value with a default of 30 seconds. Whenever a cell reselection event occurs the timer is reset. Consider a scenario in which the mobile has just reselected onto cell B from cell A. The position estimate x1 derives from a process that estimates where the device reselected cell B having been on cell A. After NB timer events, where NB is an integer 0 or larger, the device reselects to cell C. There is an uncertainty associated with the duration spent camped on cell A since the cell reselection occurred between time events NB and NB+1. The duration the device spent camped on cell B as the serving cell can be modeled as a uniform PDF resulting in

$${t}_{B} = ( {N}_{B} + \frac{1}{2} ) {T}_{s}$$

$${σ}_{B}^{2} = \frac{{T}_{s}^{2}}{12}$$

Consider that the position estimate x2 derives from the (P+1)th cell reselection event where the reselection from cell A to cell B is considered as the first cell reselection. The device will have been served by P cells with the time and uncertainty between x1 and x2 is

$$t = {T}_{S} ( {\sum }_{i = 1}^{P} {N}_{i} + \frac{P}{2} )$$

Where Ni is the number of timer events on the cell selected after the ith cell reselection event.

$${σ}_{t}^{2} = \frac{{PT}_{S}^{2}}{12}$$

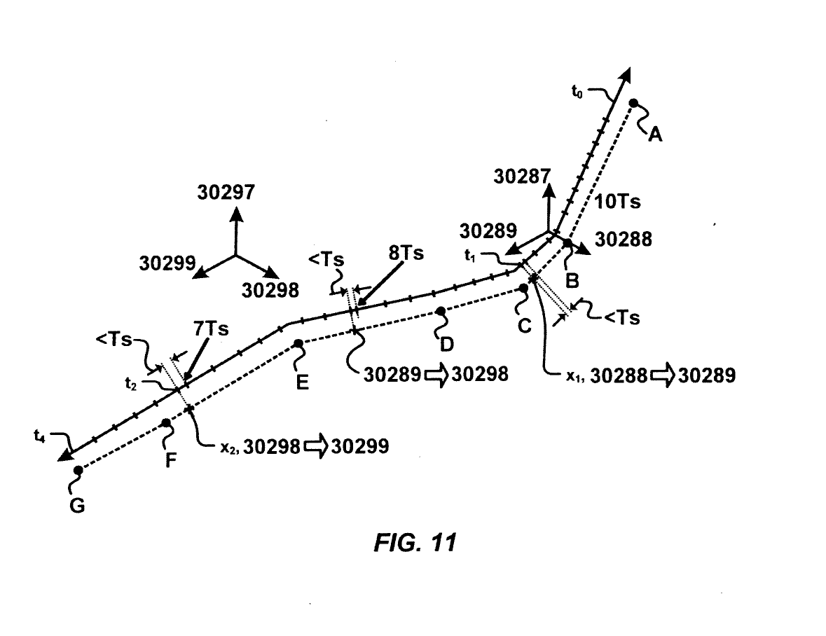

FIG. 11 illustrates the use of cell reselection events and regular sampling after the cell reselection to obtain observations of the serving cell as currently selected by the cellular mobile device. The speed is to be estimated from the cell reselection event from 30288 to 30289 and the later reselection from 30298 to 30299. In total there are 3 reselection events, which in the context of the equations above means P=2 as there is uncertainty in the time at which the reselection from 30289 to 30298 occurred and similarly uncertainty for the reselection from 30298 to 30299. N1, the number of whole sampling cycles on cell 30289 is 8 and similarly for the next cell, 30298, it is 7. Accordingly the total time is Ts*(7+8+2/2)=16 Ts.

Having identified that a given location request update contains a sequence of cells that indicate movement and then that there is at least one candidate route consistent with the measurement sequence, there is then a need to estimate the location or locations at which the cell reselection events are likely to have occurred. These positions and their uncertainty along with the associated times of reselection and optional uncertainty of time then enable a speed estimate to be derived for one or more sections of the route based on the reported measurement sequence.

In certain embodiments, the locations of cell reselection events may be determined using propagation modeling. The parameters of the deployed cellular network, including one or more parameters such as antenna azimuth, radio frequency band, cell ID, antenna location, and transmission power level can be used to predict the received signal strength at a given point for a given cell. Models for performing such calculations are known in the art and include the Hata model and the model in the 3GPP standards.

The location of cell reselection event from cell A to cell B is determined as the point on the road where the predicted received signal strength for cell B exceeds cell A. This problem can be formulated as an equation predictedRxLev(cellB, p)−predictedRxLev(cellA, p)=0 subject to the constraint that p lies on the road. There are many techniques well known in the art for finding the solution to such an equation. Minimization algorithms such as Gauss-Newton and Levenberg-Marquardt algorithm can be applied to (predictedRxLev(cellB, p)−predictedRxLev(cellA, p))̂2 can be used to obtain an estimate of the cell reselection location; where ̂2 is the squared operator. Another approach is to estimate the received signal strength for cells A and B at a series of sample points along the road network. Each of these points is then examined to find the earliest point on the road at which the predicted received signal of cell B is likely to exceed that of cell A, leading to a reselection event.

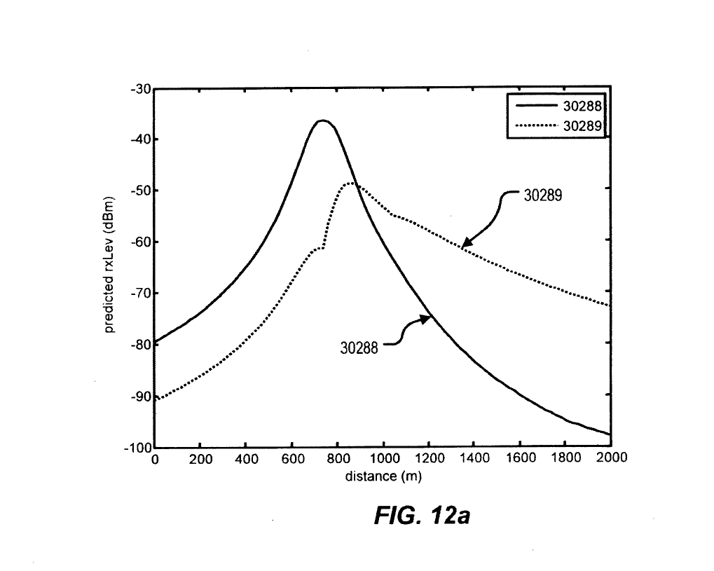

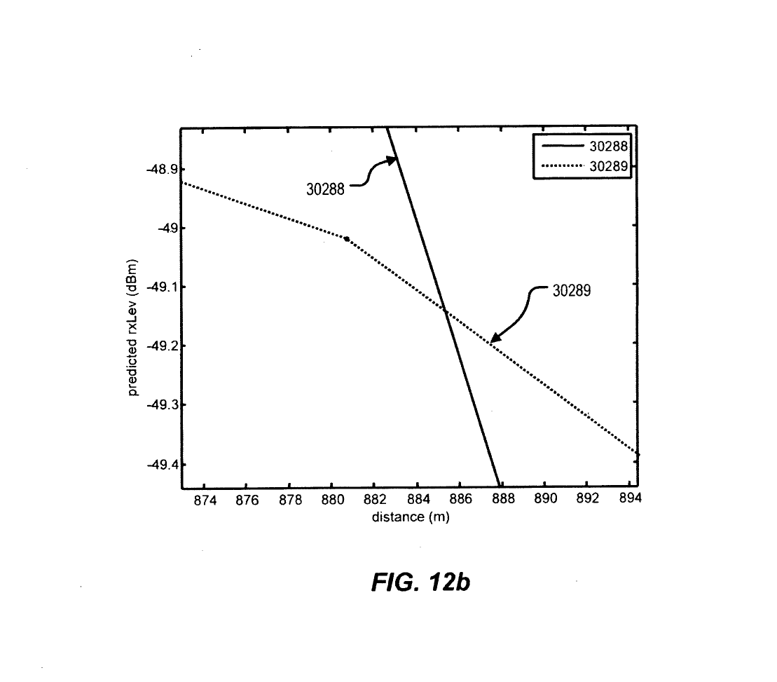

FIG. 12a illustrates the predicted signal strength for the first two cells involved in the sequence of cell reselections shown in FIG. 9. The curves were plotted using straight line between received signal strength predictions made for a set of points along the route. The serving cell was initially 30288. Further along the route, the device reselected onto 30289. The predicted location of this event is where the predicted strength for 30289 exceeds that of 30288. This is found by finding the intersection point of the two curves as show in FIG. 12b. This point is approximately 886 m along the route from a suitable starting point.

There is a trade-off between the accuracy of the spacing of the sample points along the road and the overall amount of computation required. The smaller the spacing, the greater the amount of computation required to determine the cell reselection location for a given section of road. In certain embodiments, the spacing between points is in proportion to the spacing between cell sites. The basis for this spacing can be the cell radius described elsewhere in this application. In certain embodiments, the spacing is based on the 4^{th} root of the determinant of the covariance matrix used to model the cell coverage as an ellipse as described elsewhere in this application. This spacing metric is denoted R. The sample points along the road are spaced k * R metres apart where k is a value in the range of, for example, 0.01-0.05, 0.03-0.1, or 0.08-0.2.

In cellular networks it is common for the serving cell selection algorithms to include a reselection penalty. The penalty may be defined in terms of a minimum elapsed time after reselecting. The penalty may also be defined in terms of a minimum signal strength margin by which the candidate cell must exceed the currently selected cell. In certain cases the penalty may be a combination of both. The signal strength penalty may be taken into consideration for the processing here to estimate the position on the route corresponding to the cell reselection from cell A to cell B by determining the location where the predicted received signal strength for cell B exceeds cell A by the signal strength penalty. The signal strength penalty value may be obtained from the network configuration data. The signal strength penalty value may also be obtained from the wireless device as these are commonly transmitted to the device. In certain embodiments the signal strength penalty used in the processing may be set as a constant value. Typical values for the penalty may be in the range of, for example, 0-6 dBm, or 2-8 dBm, or 3-12 dBm. The determination of the cell reselection point can then be re-expressed as equation predictedRxLev(cellB, p)−predictedRxLev(cellA, p)−penalty=0. The same techniques described elsewhere in this application can then be used to obtain the estimated location and associated uncertainty for the cell reselection.

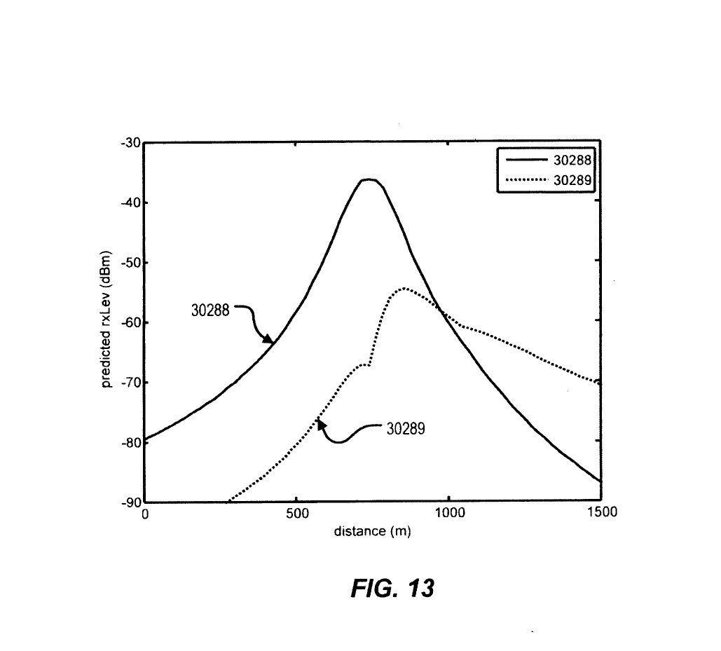

FIG. 13 illustrates the estimated cell reselection point along the route when a reselection penalty of 6 dBm is applied to the first cell reselection, from 30288 to 30289, in the scenario illustrated in FIG. 9. This reselection penalty is equivalent to lowering the predicted signal strength of the cell that the device is reselecting onto and it is this predicted received signal less the reselection penalty which is plotted for cell 30289. The curves were plotted using straight line between received signal strength predictions made for a set of points along the route. The serving cell was initially 30288. Further along the route, the device reselected onto 30289. The predicted location of this event with a reselection penalty being taken into consideration the point at which the two curves intersect. This point is approximately 975 m along the route from the arbitrarily selected starting point. The scenario plotted in FIG. 9 shows this reselection point on the road as the reselection points in that figure took into consideration a reselection penalty of 6 dBm.

Certain cellular network and road topologies can result in there being two points on the road that solve the cell reselection equation. This ambiguity can be resolved by using the direction of travel along the road that the route under consideration takes. Consider the cell reselection from cell A to cell B. The ambiguity is resolved by selecting the point at which, in the direction of travel, the predicted received signal strength for cell A is less than cell B less the reselection penalty if it is being applied.

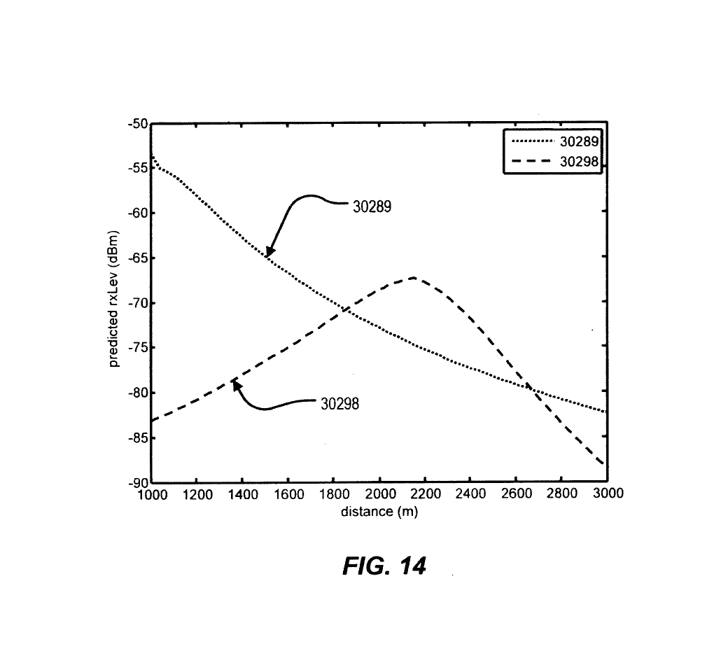

An example of an ambiguous solution to the predicted received signal strength is illustrated in FIG. 14 and derives from the scenario illustrated in FIG. 9. The reselection from cell 30289 to cell 30298, with a 6 dBm reselection penalty applied is shown to be possible at occur two locations. In the scenario where the reselection penalty is applied, Cell 30289 is estimated to be selected approximately 975 m from the nominal start point and thus the first point at which a reselection from cell 30289 to cell 30298 is at approximately 1850 m from the nominal start point. This is the reselection point shown in FIG. 9 for reselecting from 30289 to 30298.

The accuracy of the estimated cell reselection location can be affected by one or more sources. These include, for example, the accuracy of the network parameters used in the propagation modeling, the empirical nature of the propagation model equations, the effects of local terrain and environment on the actual received signal strength at a given location, or combinations thereof. The latter of these is commonly referred to as shadow fading. The likely effect of these error sources on the cell reselection location estimate can be estimated by modeling each such source and then determining how far along the road, in each direction, the location estimate would change due to the combined effect of the errors. One method for determining this effect is to use Monte Carlo modeling. The cell reselection location estimate for a given cell reselection on a given road is determined a number of times with each determination made with a randomly generated value for each of the input parameters according to the error model for that parameter. The result of this is an ensemble of values of the cell relocation event enabling the uncertainty to be determined. An example uncertainty measure is to take the standard deviation of the location estimates as measured along the road. The Monte Carlo approach, whilst offering accuracy and the ability to model a diverse set of error sources, can be computationally intensive. In the preferred embodiment the error sources, of which shadow fading will typically dominate, are modeled as an uncertainty in the received signal strengths estimated by propagation modeling. The effect of the error sources can then be found by solving the two equations:

predictedRxLev(cellB, p1)−predictedRxLev(cellA, p1)−penalty+rxUncertainty=0, and predictedRxLev(cellB, p2)−predictedRxLev(cellA, p2)−penalty−rxUncertainty=0 subject to p1 and p2 being on the road.

When observed along the route p1 occurs first and is referred to as the “early” reselection point, and p2 is referred to as the “late” reselection point. Typical values for the rxUncertainty are in the range 0-6 dBm, 3-9 dBm, and 2-12 dBm.

The points p1 and p2 will not necessarily be equal distances from the predicted point at which the reselection occurs. This is due to the non-linear nature of received signal strength as a function of distance and angle to a cell. The uncertainty is estimated as a function of the distances from the estimated reselection location to p1 and to p2. In certain embodiments this can be the maximum distance from the cell reselection estimate to p1 and p2. In other embodiments it may be the minimum. In the preferred embodiment, the uncertainty is set as the average of the distance from the cell reselection point to p1 and p2.

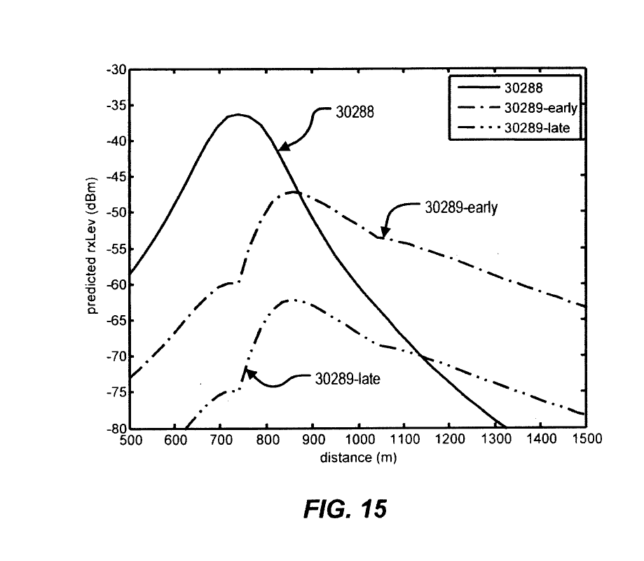

FIG. 15 illustrates the uncertainty in the cell reselection location when that uncertainty is modeled as arising from variations in the predicted signal strength. In this example the shadow fading is set as 7.5 dBm with a reselection penalty of 6 dBm. The example pertains to the cell reselection for cell 30288 to cell 30289 from the scenario illustrated in FIG. 9. The early cell reselection point along is approximately 975 m from the nominal start of the route whilst the late cell reselection is at 1140 m along the route. The uncertainty is then computed to be 82.5 m.

In yet another embodiment the location of cell reselection events and the associated uncertainty are based upon empirical measurements of actual cell reselection events made over the roads of interest and ideally recorded multiple times in both directions. Such empirical measurements can be obtained by using a system fitted with an accurate positioning device such as a GPS receiver and a cellular datalogger to record the serving cell at each location, and optionally the received signal level of all cells hearable at each location. Such logs can then be used to determine the location where cell reselection between a given pair of cells is most likely to have occurred and the distance range over which it could occur.

In yet another embodiment, the location of cell reselection events uses a combination of propagation modeling and empirical measurements. One means of combining both methods is to use empirical measurements where there are sufficient measurements available for the given road segment and direction and to use the RF prediction methods when there are not.

For a given traffic flow estimate, each road segment being modeled will have zero or more speed estimates in each direction. The ith measurement on the jth road segment in the direction d is denoted v_{ijd}. The direction d is denoted f for the forwards direction, from segment start node to end node and b for backwards from the segment end node to start node. Associated with each speed estimate is the uncertainty σ_{ijd}. All of the speed estimates for a given road segment and direction are combined to produce an overall estimate of the speed and uncertainty of that speed.

One means of producing such an estimate is to average the estimates arising from each of the speed estimates. Another means is to take the weighted average which takes into account the uncertainty on each of the measurements:

$${v}_{jd} = \frac{{\sum }_{i = 1}^{N} \frac{{v}_{ijd}}{{σ}_{ijd}^{2}}}{{\sum }_{i = 1}^{N} \frac{1}{{σ}_{ijd}^{2}}}$$

The associated uncertainty is

$${σ}_{jd} = \frac{1}{\sqrt{{\sum }_{i = 1}^{N} \frac{1}{{σ}_{ijd}^{2}}}}$$

Implicit in this formula is an assumption that the errors in the data are independent and unbiased. This may not necessarily be the case and as such may result in the calculated uncertainty value being too small. In a preferred embodiment the uncertainty is computed as the minimum of all of the uncertainties that contributed to the weighted mean:

$${σ}_{jd} = {min}_{i} {σ}_{ijd}$$

Using all of the speed estimates as is done when taking the mean or weighted mean assumes that all of the speed estimates derive from the same population, that is all of the measurements used to estimate the speed derive from vehicles that are travelling on the given road segment. This may not necessarily be the case. In particular some of the measurements may derive from vehicles that have terminated their journey, just started their journey or otherwise temporarily broken their journey, for example to refuel. When using a simple average or weighted average such vehicles may have an impact on the estimated speed as they introduce low values into the ensemble of speed estimates. Further they may have an even greater impact on the weighted mean due to low speed estimates typically having lower uncertainty values resulting in the lower speed estimates making a greater contribution to the overall estimate.

In certain embodiments, the overall speed estimate is obtained by using an order statistic. The ensemble of n speed estimates for jth road segment and direction d are sorted from smallest to largest. The sorted speed estimates are denoted v_{ijd} with v_{ljd} being the smallest and V_{njd} the largest. The speed estimate for that segment and direction is then determined as that speed corresponding to the sample quantile of order p where p represents the fraction along the list and is in the range (0, 1). An exemplary method of determining a sample quartile is disclosed in http://www.math.uah.edu/stat/sample/OrderStatistics.pdf. The speed estimate is defined as:

k=└(n+1)p┘

q=(n+1)p−k

v_{jd}=(1−q)V_{kjd}+qV_{(k+1)jd}

Due to the likelihood of receiving some low speed estimates corresponding to vehicles that are not moving on the road of interest, typical values for p include 0.5, the sample median, and in general will lie in the range of, for example, (0.4-0.75), (0.6-0.9), (0.7-0.95), or (0.8-0.99).

An advantage of this application of order statistics is a degree of robustness against route misclassification. Techniques that combine measurements can be affected by measurements which are incorrectly applied to a given road segment as would occur should a measurement sequence be applied to an incorrect route.

The uncertainty of the speed estimate derived using order statistics may be based upon the range of speed estimates from a contiguous subset of the sorted speed estimates. Examples of such ranges are the inter-quartile range and the range of values of m speed estimates either side of the quantile of order p. In the preferred embodiment the uncertainty is expressed as half of the inter-quartile distance.

In certain embodiments, a sequence of cell reselection measurements may be obtained from the core elements of a cellular network. Such events may be obtained for example via probes that monitor communications between system elements that manage cell handovers during a call for example, or during a packet data session. When a voice or data connection experiences 2 or more handover events then a sequence of measurements can be obtained that may be suitable for estimating speed along a part of the traffic network as described herein.

In certain embodiments, charging records, in some cases known as call detail records (CDRs) may also provide information suitable for use in traffic flow measurement. Such records may include a list of the cells to which a device connected during the course of a call or session. These lists and associated timestamps may be applied to the processing methods detailed herein to measure the flow of traffic on certain roads.

In certain embodiments, it may be desirable to alert drivers within a certain area to severe congestion or an incident on the road ahead. For users of connected navigation devices, this may be accomplished by having the device periodically connect to a traffic server such as described herein. The navigation device may submit information describing the current position and heading. The server in turn may detect that the vehicle is following a route that is likely to be affected by the incident and may provide alert information to the device to present to the user advising them to select an alternative route. For other users however, not currently using a connected navigation device it may be desirable to provide automatic alerts concerning such incidents. In this case, a challenge arises in relation to determining which users are currently travelling and in particular following a route that is likely to be affected by the incident. Naturally it is not practical to monitor the location of all users of the road and continually check whether they are heading towards an incident.

In certain embodiments, referring to FIG. 2, the traffic server 25 can be interfaced to a cell broadcast centre 40. In a case where an incident is detected that warrants advising motorists, the traffic server identifies cells situated along the route leading towards the incident. The traffic server then generates an encoded message describing the incident and activates the broadcast of this message on the identified cells. Preferably the message may be transmitted on a broadcast channel other than 50 in order not to interfere with other messages which may be broadcast in general from time to time. A SIM toolkit applet is provided on the SIM card to manage the reception of the cell broadcast message and present it to the user. The alert may be presented as a text popup on the screen and may optionally be accompanied by an audio tone.

In certain embodiments, the broadcast message may also include a sequence of cell information corresponding to the route, enabling the applet to determine whether the corresponding device is indeed progressing along the road. In this way the applet can discriminate travelling users who should be presented with the alert from other stationary users, for example in nearby dwellings or commercial premises who are also served by the same cells, in order to avoid irrelevant alerts being presented to them.

In certain embodiments the cell broadcast reception and control of the alert presentation functionality may be integrated into the same applet responsible for the traffic measurement agent functions.

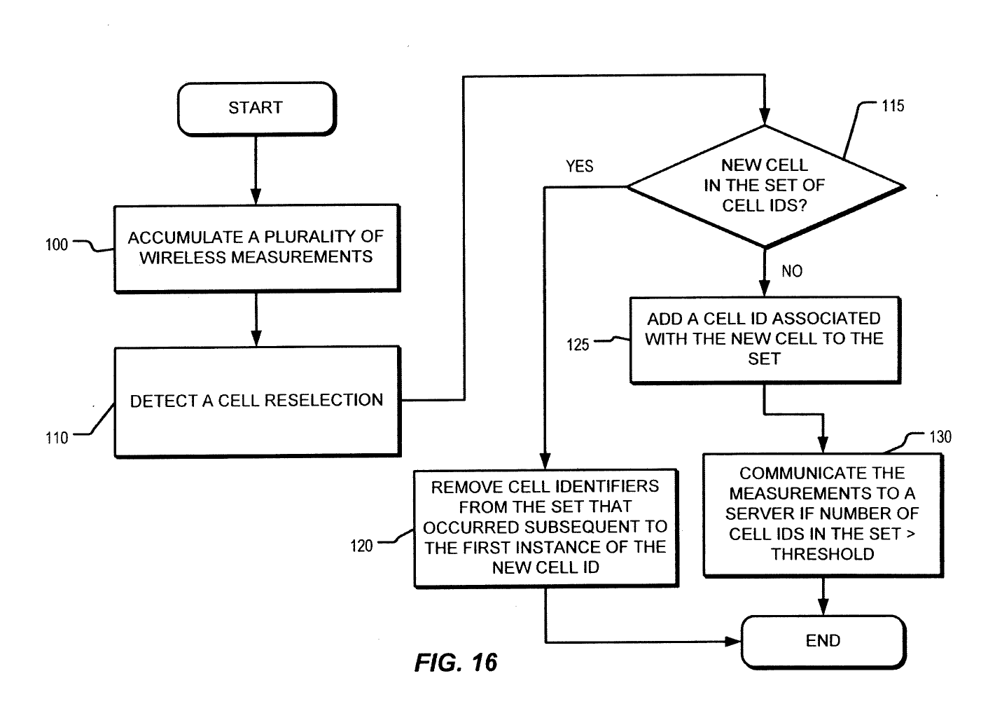

FIG. 16 illustrates an exemplary method of collecting and transmitting radio communications network measurements from a mobile radio terminal for use in a system of estimating traffic flow speed on a road segment in accordance with certain embodiments. In step 100 the mobile radio terminal accumulates a plurality of wireless measurements in a memory (e.g., DRAM or on the SIM card), wherein the measurements include a set of cell identifiers associated with cells that previously served the mobile radio terminal. In step 110, the mobile radio terminal detects a cell reselection to a new cell. Detecting this reselection may be done by periodic sampling and/or resetting a timer based on the reselection as described above. The mobile radio terminal then determines if the cell identifier associated with the new cell is in the set of cell identifiers in step 115. If not, then the mobile radio terminal adds a cell identifier associated with the new cell to the set of cell identifiers in step 125, and communicates the accumulated radio communications network measurements to a traffic flow measurement server if the number of cell identifiers in the set of cell identifiers exceeds a threshold (e.g., 3, 4, 5, 6, 7, 8, 9, 10, 11, 12, 13, 14, or 15) in step 130. Otherwise, in step 120, the mobile radio terminal removes one or more cell identifiers from the set of cell identifiers, wherein the one or more cell identifiers removed include cell identifiers subsequent to a first instance of the cell identifier associated with the new cell. As a result of this process, reporting of radio communications network measurements is minimized when the mobile radio terminal is stationary.

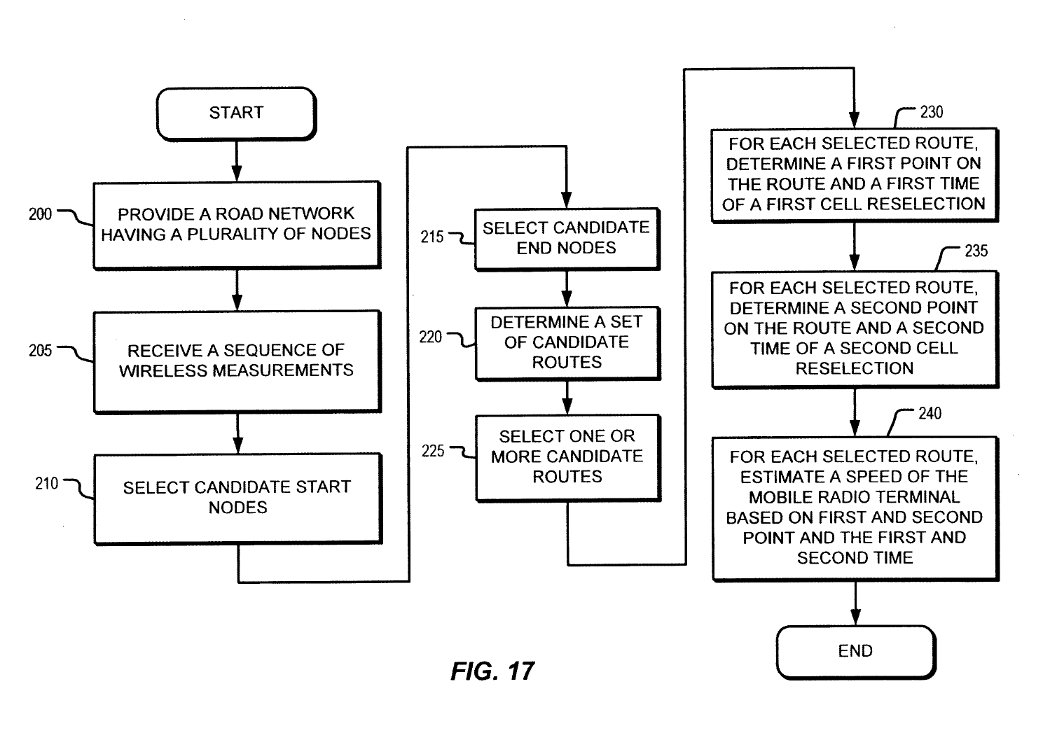

FIG. 17 illustrates an exemplary method for estimating the speed of a mobile radio terminal on a road segment in accordance with certain embodiments. In step 200, the traffic server provides a road network having a plurality of nodes, each node being connected to one or more road segments, wherein the road network models a physical road topology of a geographic area. This road network may be obtained from a commercial vendor of such traffic networks as would be known to one of skill in the art. Next, in step 205 the traffic server receives a sequence of wireless measurements. The wireless measurements include a number of cell identifiers, and also can include one or more other parameters such as received power levels and round trip delays. In certain embodiments, this sequence may be received from one or more mobile radio terminals. In other embodiments, this sequence may be received from radio communications network components (e.g., probes in the network).

Next, the traffic server determines a route through the road network that the mobile radio terminal could have traveled based on the sequence. This determination includes the following. First, in step 210 the server selects one or more candidate start nodes based on distance (e.g., Mahalanobis distance) from each node in the road network to a first cell identifier in the sequence of cell identifiers. In step 215, the server selects one or more candidate end nodes based on distance from each node in the road network to a second cell identifier in the sequence of cell identifiers. In step 220, the server determines a set of candidate routes by calculating a path through the road network for each combination of candidate start nodes and candidate end nodes. In certain embodiments, determining the path for each combination comprises calculating a shortest path from each start node to each end node using, for example, Djikstra's algorithm. Also, in certain embodiments the server removes redundant routes (i.e. routes that are merely subsets of other routes.) In step 225, the server selects one or more candidate routes having a likelihood of being the route the mobile radio terminal traveled that is above a threshold. This likelihood can be based on, for example, summing the distances from a point corresponding to each cell in the measurement sequence to the nearest point on the route to generate a chi-squared statistic with a number of degrees of freedom equal to the number of measurements in the sequence, and then comparing a cumulative probability corresponding to this chi-squared statistic to a threshold. The threshold may be, for example, 0.5-0.9, 0.75-0.95, or 0.8-0.99.

For each selected route, in step 230 the server determines a first point on the selected route and a first time corresponding to a first cell reselection event from the sequence of measurements. Then, for each selected route, in step 235 the server determines a second point on the selected route and a second time corresponding to a second cell reselection from the sequence of measurements. And in step 240, for each selected route the server estimates a speed of the mobile radio terminal on at least one road segment between the first and second point based on a distance between the first and second point and a difference between the first and second time.

In certain embodiments, the server aggregates the speed estimates from various mobile radio terminals to estimate a traffic flow speed over a road segment. In these embodiments, the server obtains speed estimates over a road segment as described above. Then the server calculates an average or weighted average of the speed estimates over the road segment. Alternatively, the server may calculate an order statistic of the speed estimates over the road segment.

In addition, in certain embodiments the server may schedule the transmission of the sequences of wireless measurements to reduce the communication load over the network. In these embodiments, the server generates a history of speed estimates for the road segment, wherein the history includes identifiers of mobile radio terminals that contributed to the speed estimates. Next, the server analyzes the history as described above to select a set of mobile radio terminals sufficient to provide a speed estimate for the road segment, the speed estimate having a predetermined accuracy such as, for example, below 1%, below between 2 and 5%, below between 3% and 10%, below between 5% and 20%. The server then schedules the selected set of mobile radio terminals to transmit sequences of wireless measurements to the server at a first rate. This can be done by, for example, sending configuration messages to these mobile radio terminals to transmit at a certain periodicity or after a certain number of wireless measurements have been accumulated. The server also schedules at least one of the remainder of mobile radio terminals in the history to transmit sequences of wireless measurements to the server at a second rate. And the second rate is lower than the first rate such that a communication load on a radio communication network due to transmission of the sequences of wireless measurements to the server is reduced. Naturally, the more of the non-selected terminals that transmit at the second rate, the more communications load will be reduced.

The exemplary approaches described may be carried out using any suitable combinations of software, firmware and hardware and are not limited to any particular combinations of such. Computer program instructions for implementing the exemplary approaches described herein may be embodied on a tangible, non-transitory, computer-readable storage medium, such as a magnetic disk or other magnetic memory, an optical disk (e.g., DVD) or other optical memory, RAM, ROM, or any other suitable memory such as Flash memory, memory cards, etc.

Additionally, the disclosure has been described with reference to particular embodiments. However, it will be readily apparent to those skilled in the art that it is possible to embody the disclosure in specific forms other than those of the embodiments described above. The embodiments are merely illustrative and should not be considered restrictive. The scope of the disclosure is given by the appended claims, rather than the preceding description, and all variations and equivalents which fall within the range of the claims are intended to be embraced therein.

1. A processor-implemented method for estimating a speed of a mobile radio terminal traveling on at least one road segment comprising:
a. providing a road network having a plurality of nodes, each node being connected to one or more road segments, wherein the road network models a physical road topology of a geographic area;
b. receiving a sequence of wireless measurements, wherein the sequence includes a plurality of cell identifiers;
c. determining a route through the road network that the mobile radio terminal could have traveled based on the sequence, wherein determining the set of routes includes,
i. selecting one or more candidate start nodes based on distance from each node in the road network to a first cell identifier in the sequence,
ii. selecting one or more candidate end nodes based on distance from each node in the road network to a second cell identifier in the sequence,
iii. determining a set of candidate routes by calculating a path through the road network for each combination of candidate start nodes and candidate end nodes,
iv. selecting a candidate route having a likelihood of being the route the mobile radio terminal traveled that is above a threshold,
d. determining a first point on the selected route and a first time corresponding to a first cell reselection event from the sequence;
e. determining a second point on the selected route and a second time corresponding to a second cell reselection from the sequence; and
f. estimating a speed of the mobile radio terminal on at least one road segment between the first and second point based on a distance between the first and second point and a difference between the first and second time.

2. The processor-implemented method of claim 1 wherein the sequence is partitioned into a plurality of sub-sequences.

3. The processor-implemented method of claim 1 wherein determining the first or second point on the selected route comprises estimating a location on the route where reselection has a highest likelihood of occurring based on propagation modeling.

4. The processor-implemented method of claim 1 wherein determining the first or second point on the selected route comprises empirically determining a location on the route where reselection has a highest likelihood of occurring.

5. The processor-implemented method of claim 1 wherein the distance from each node in the road network to the first or second cell identifier is a Mahalanobis distance.

6. The processor-implemented method of claim 1 wherein calculating a path through the road network for each combination of candidate start nodes and candidate end nodes comprises calculating a shortest path for each candidate route with the Djikstra algorithm.

7. The processor-implemented method of claim 1 wherein determining the set of candidate routes further comprises removing at least one redundant route.

8. The processor-implemented method of claim 1 wherein the sequence is received from a mobile radio terminal.

9. The processor-implemented method of claim 1 wherein the sequence is received from a radio communications network probe.

10. A processor-implemented method of estimating a traffic flow speed over a road segment comprising:
a. obtaining one or more speed estimates over a road segment in accordance with the method of claim 1; and
b. calculating a weighted average of the one or more speed estimates over the road segment.

11. A processor-implemented method of estimating a traffic flow speed over a road segment comprising:
a. obtaining one or more speed estimates over a road segment in accordance with the method of claim 1; and
b. calculating an order statistic of the one or more speed estimates over the road segment.

12. The method of claim 10 wherein obtaining one or more speed estimates over a road segment further comprises:
a. generating a history of speed estimates for the road segment, wherein the history includes a plurality of identifiers of mobile radio terminals that contributed to the speed estimates;
b. analyzing the history to select a set of mobile radio terminals sufficient to provide a speed estimate for the road segment having a predetermined accuracy;
c. scheduling the selected set of mobile radio terminals to transmit sequences of wireless measurements to a server at a first rate; and
d. scheduling at least one of a remainder of mobile radio terminals in the history to transmit sequences of wireless measurements to the server at a second rate;
e. wherein the second rate is lower than the first rate such that a communication load on a radio communication network due to transmission of the sequences of wireless measurements to the server is reduced.

13. A processor-implemented method of collecting and transmitting radio communications network measurements from a mobile terminal for use in a system of estimating a traffic flow speed on road segments, the method comprising:
a. accumulating a plurality of wireless measurements in a memory of a mobile radio terminal, wherein the wireless measurements include a set of cell identifiers associated with cells that previously served said mobile radio terminal;
b. detecting a cell reselection to a new cell;
c. if the cell identifier associated with the new cell is not in the set of cell identifiers,
i. adding a cell identifier associated with the new cell to the set of cell identifiers, and
ii. communicating the plurality of wireless measurements to a traffic flow measurement server if a number of cell identifiers in the set of cell identifiers exceeds a threshold; and
d. if the cell identifier associated with the new cell is in the set of cell identifiers, removing one or more cell identifiers from the set of cell identifiers, wherein the one or more cell identifiers removed include cell identifiers subsequent to a first instance of the cell identifier associated with the new cell, such that reporting of wireless measurements is minimized when the mobile radio terminal is stationary.

14. The processor-implemented method of claim 13 wherein detecting a cell reselection to a new cell comprises periodically obtaining a current serving cell identifier.

15. The processor-implemented method of claim 13 wherein detecting a cell reselection to a new cell comprises resetting a timer when a cell reselection occurs.

16. The processor-implemented method of claim 13 wherein the mobile radio terminal collects one or more wireless measurements in idle mode.

17. The processor-implemented method of claim 13 wherein said threshold is set by a configuration message received from the traffic flow measurement server.

18. An article of manufacture comprising a non-transitory computer readable storage medium having computer program instructions adapted to cause a processing system to execute a method comprising:
a. providing a road network having a plurality of nodes, each node being connected to one or more road segments, wherein the road network models a physical road topology of a geographic area;
b. receiving a sequence of wireless measurements, wherein the sequence includes a plurality of cell identifiers;
c. determining a route through the road network that the mobile radio terminal could have traveled based on the sequence, wherein determining the set of routes includes,
i. selecting one or more candidate start nodes based on distance from each node in the road network to a first cell identifier in the sequence,
ii. selecting one or more candidate end nodes based on distance from each node in the road network to a second cell identifier in the sequence,
iii. determining a set of candidate routes by calculating a path through the road network for each combination of candidate start nodes and candidate end nodes,
iv. selecting a candidate route having a likelihood of being the route the mobile radio terminal traveled that is above a threshold,
d. determining a first point on the selected route and a first time corresponding to a first cell reselection event from the sequence;
e. determining a second point on the selected route and a second time corresponding to a second cell reselection from the sequence; and
estimating a speed of the mobile radio terminal on at least one road segment between the first and second point based on a distance between the first and second point and a difference between the first and second time.

19. An article of manufacture comprising a non-transitory computer readable storage medium having computer program instructions adapted to cause a processing system to execute a method comprising:
a. accumulating a plurality of wireless measurements in a memory of a mobile radio terminal, wherein the wireless measurements include a set of cell identifiers associated with cells that previously served said mobile radio terminal;
b. detecting a cell reselection to a new cell;
c. if the cell identifier associated with the new cell is not in the set of cell identifiers,
i. adding a cell identifier associated with the new cell to the set of cell identifiers, and
ii. communicating the plurality of wireless measurements to a traffic flow measurement server if a number of cell identifiers in the set of cell identifiers exceeds a threshold; and
d. if the cell identifier associated with the new cell is in the set of cell identifiers, removing one or more cell identifiers from the set of cell identifiers, wherein the one or more cell identifiers removed include cell identifiers subsequent to a first instance of the cell identifier associated with the new cell, such that reporting of wireless measurements is minimized when the mobile radio terminal is stationary.

20. The article of manufacture of claim 19 wherein the computer readable storage medium is a SIM card.

21. A traffic server configured to estimate a speed of a mobile radio terminal traveling on at least one road segment comprising a processing system and a memory coupled to the processing system, wherein the processing system is configured to execute steps comprising:
a. providing a road network having a plurality of nodes, each node being connected to one or more road segments, wherein the road network models a physical road topology of a geographic area;
b. receiving a sequence of wireless measurements, wherein the sequence includes a plurality of cell identifiers;
c. determining a route through the road network that the mobile radio terminal could have traveled based on the sequence, wherein determining the set of routes includes,
i. selecting one or more candidate start nodes based on distance from each node in the road network to a first cell identifier in the sequence,
ii. selecting one or more candidate end nodes based on distance from each node in the road network to a second cell identifier in the sequence,
iii. determining a set of candidate routes by calculating a path through the road network for each combination of candidate start nodes and candidate end nodes,
iv. selecting a candidate route having a likelihood of being the route the mobile radio terminal traveled that is above a threshold,
d. determining a first point on the selected route and a first time corresponding to a first cell reselection event from the sequence;
e. determining a second point on the selected route and a second time corresponding to a second cell reselection from the sequence; and
f. estimating a speed of the mobile radio terminal on at least one road segment between the first and second point based on a distance between the first and second point and a difference between the first and second time.

22. A mobile radio terminal configured to collect and transmit radio communications network measurements for use in a system of estimating a traffic flow speed on road segments comprising a processing system and a memory coupled to the processing system, wherein the processing system is configured to execute steps comprising:
a. accumulating a plurality of wireless measurements in a memory of a mobile radio terminal, wherein the wireless measurements include a set of cell identifiers associated with cells that previously served said mobile radio terminal;
b. detecting a cell reselection to a new cell;
c. if the cell identifier associated with the new cell is not in the set of cell identifiers,
i. adding a cell identifier associated with the new cell to the set of cell identifiers, and
ii. communicating the plurality of wireless measurements to a traffic flow measurement server if a number of cell identifiers in the set of cell identifiers exceeds a threshold; and
d. if the cell identifier associated with the new cell is in the set of cell identifiers, removing one or more cell identifiers from the set of cell identifiers, wherein the one or more cell identifiers removed include cell identifiers subsequent to a first instance of the cell identifier associated with the new cell, such that reporting of wireless measurements is minimized when the mobile radio terminal is stationary.
